(19) United States
(12) Patent Application Publication
(10) Pub. No.: US 2018/0303079 A1
(43) Pub. Date: Oct. 25, 2018

(54) Acoustic Automated Detection, Tracking and Remediation of Pests and Disease Vectors

(71) Applicant: The Trustees of Columbia University in the City of New York, New York, NY (US)

(72) Inventors: Szabolcs Marka, New York, NY (US); Imre Bartos, New York, NY (US); Zsuzsanna Marka, New York, NY (US)

(21) Appl. No.: 15/768,291

(22) PCT Filed: Oct. 14, 2016
(86) PCT No.: PCT/US16/56963

§ 371 Date: Apr. 13, 2018

Related U.S. Application Data
(60) Provisional application No. 62/250,972, filed on Nov. 4, 2015.
(60) Provisional application No. 62/250,953, filed on Nov. 4, 2015.
(60) Provisional application No. 62/242,759, filed on Oct. 16, 2015.

(51) Int. Cl. A01M 1/02; A01M 1/14

(52) U.S. Cl. CPC A01M 1/026; A01M 1/226; A01M 1/14

(57) ABSTRACT

Techniques for detecting and tracking pests such as disease vectors include a directional acoustic sensor or array such as a phased array of microphones or a directional microphone; at least one processor; and at least one memory including one or more sequences of instructions. The memory and instructions and processor cause an apparatus to track an individual or swarm of pests based on direction and acoustic signatures within a beam of the directional acoustic sensor or array, in which the acoustic signature uniquely identifies a type of pest. In some embodiments, remedial apparatus is directed to impose remedial action against the individual or swarm of pests. In some embodiments the remedial apparatus includes an optical barrier.

### CROSS-REFERENCE TO RELATED APPLICATIONS

This application claims benefit of: Provisional Appln. 62/242,759, filed Oct. 16, 2015; Provisional Appln. 62/250,953, filed Nov. 4, 2015; and Provisional Appln. 62/250,972, filed Nov. 4, 2015 under 35 U.S.C. § 119(e), the entire contents of each of which are hereby incorporated by reference as if fully set forth herein,

### BACKGROUND

Insects serve as pests and disease vectors. For example, the Anopheles gambiae and Aedes aegypti mosquito not only annoys humans and livestock by biting but also spreads malaria and Dengue fever. Similarly, tsetse flies are biological vectors of trypanosomes, which cause human sleeping sickness and animal trypanosomiasis. Triatominae (kissing bugs) spread Chagas disease.

Locating, measuring, and interacting with such swarms in real time as they form has been extremely difficult on the field. Reliable tracking of individual pests unobtrusively as they traverse the home, village or the wild has not been demonstrated. Trap-less counting and characterization of pest populations around humans has not been achieved.

Mosquito control is still an unsolved problem in many developing countries. Malaria is epidemic in many places, including sub-Saharan Africa where the majority of the Earth's malaria fatalities occur. Generic control measures rely on toxic chemical and biological agents, while repellents in conjunction with mosquito nets provide additional defense. While these are efficient, they also pose direct danger and serious discomfort to users, albeit small when compared to the grave dangers of malaria. Traditional measures seem to be approaching their peak efficiency in practice, while the malaria epidemic is still ongoing.

As stated above, various approaches employ toxic materials. For example, Tillotson et al. (US Patent application Publication 2010/0286803) describes a system for dispensing fluid (such as insect repellant) in response to a sensed property such as an ambient sound (e.g., known signatures of insect wing beat frequencies and their harmonics). These are proximity sensors that determine that an insect is close enough to warrant fluid dispensing when the amplitude of the wing beat frequency exceeds some threshold value over the background noise.

### SUMMARY

In the work presented here it is determined that a direction of approach of an individual or swarm of pests, such as mosquitos, can be detected acoustically and passively, then used to control some environmentally friendly remedial action, such as optical barriers. In some embodiments the remedial action involves one or more unmanned aerial vehicles (UAVs) with sticky surfaces. In some embodiments, one or more uninvited UAVs constitute the pests.

In a first set of embodiments, at least one directional acoustic sensor is used to determine past, present or forecast track of an individual or swarm of pests based on direction and acoustic signatures that uniquely identify a type of pest (e.g., male or female Aedes Aegypti mosquito). In some of these embodiments, the determine past, present or forecast track of the individual or swarm is used to activate or target some remedial action, such as activating a light barrier.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1 is a block diagram that illustrates example system in operation to track (including determining past locations, current location or forecast of future locations, or some combination, of) a swarm of insects by triangulation, according to an embodiment;

FIG. 2A is a graph that illustrates example directional microphone with cardioid response for use in a system to locate and track an individual or swarm of pests, according to an embodiment;

FIG. 2B is a graph that illustrates example directional microphone with shotgun response for use in a system to locate and track an individual or swarm of pests, according to an embodiment;

FIG. 3A is a graph that illustrates example acoustic signature of a female Anopheles gambiae mosquito for use in a system to locate and track an individual or swarm of pests, according to an embodiment;

FIG. 3B is a graph that illustrates an example acoustic spectrum of data collected with a parabolic microphone, according to an embodiment;

FIG. 4A is a block diagram that illustrates example use of an acoustic phased array in a system to locate, track and take remedial action against an individual or swarm of pests, according to an embodiment;

FIG. 4B is a block diagram that illustrates example use of a virtual (or synthetic) acoustic phased array in a system to locate, track and take remedial action against an individual or swarm of pests, according to an embodiment;

FIG. 4C is a block diagram that illustrates example use of a highly directional microphone (e.g., a shotgun microphone) in a motorized pivot in a system to locate, track and take remedial action against an individual or swarm of pests, according to an embodiment;

FIG. 4D is a block diagram that illustrates example use of a pair of shotgun microphones to locate, track or take remedial action against an individual or swarm of pests, according to another embodiment;

FIG. 4E is a block diagram that illustrates example use of twelve shotgun microphones pointed 30 degrees apart in a system to locate, track and take remedial action against an individual or swarm of pests, according to another embodiment;

FIG. 5A is a graph that illustrates example directional data from beamforming signals received at a phased array, according to an embodiment;

FIG. 5B and FIG. 5C are graphs that illustrate example experimental data using the system of FIG. 4D, according to an embodiment;

FIG. 6 is a block diagram that illustrates example use of multiple phased arrays in a system to locate, track and take remedial action against an individual or swarm of pests, according to an embodiment;

FIG. 7 is a photograph of an example experimental setup to detect unique acoustic signatures of a pest, according to an embodiment;

FIG. 8A and FIG. 8B are graphs that illustrate example spectrograms that display unique acoustic signatures of an individual and swarm, respectively, according to various embodiments;

FIG. 9A and FIG. 9B are graphs that illustrate example spectrograms that display unique acoustic signatures of an individual male and individual female on various scales, respectively, according to one embodiment;

FIG. 10A through FIG. 10C are block diagrams that illustrate various remedial systems for generating an optical barrier to pests, according to various embodiments;

FIG. 11A and FIG. 11B are block diagrams that illustrate operation of example remedial system based on a UAV, according to an embodiment;

FIG. 11C is a block diagram that illustrates operation of example remedial system based on a UAV with an on board directional microphone or array, according to another embodiment;

FIG. 12A through FIG. 12E are photographs that illustrates various UAVs that are example pests or example platforms for a directional microphone or array or a virtual phased array or remedial system or both, according to various embodiments;

FIG. 13 is a photograph of an example experimental setup to detect unique acoustic signatures of a UAV, according to an embodiment;

FIG. 14A is a graph that illustrates an example pressure signal at an array of four microphones from a single UAV, according to an embodiment;

FIG. 14B is a graph that depicts an example relative phase of pressure signals at four microphones from a single UAV over a few cycles of a dominant frequency, according to an embodiment;

FIG. 14C through FIG. 14G are graphs that illustrate example spectrograms that display unique acoustic signatures of various operations of various UAVs, according to various embodiments;

FIG. 15 is a block diagram that illustrates a computer system upon which an embodiment may be implemented;

FIG. 16 illustrates a chip set upon which an embodiment may be implemented; and

FIG. 17 is a block diagram that illustrates example components of a mobile terminal (e.g., cell phone handset) for acoustic measurements, communications or processing, or some combination, upon which an embodiment may be implemented.

### DETAILED DESCRIPTION

A method and apparatus are described for automated acoustic detection and tracking of pests and disease vectors. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains uncertainty necessarily resulting from the standard deviation found in their respective testing measurements at the time of this writing. Furthermore, unless otherwise clear from the context, a numerical value presented herein has an implied precision given by the least significant digit. Thus a value 1.1 implies a value from 1.05 to 1.15. The term “about” is used to indicate a broader range centered on the given value, and unless otherwise clear from the context implies a broader rang around the least significant digit, such as “about 1.1” implies a range from 1.0 to 1.2. If the least significant digit is unclear, then the term “about” implies a factor of two, e.g., “about X” implies a value in the range from 0.5× to 2×, for example, about 100 implies a value in a range from 50 to 200. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Some embodiments of the invention are described below in the context of detecting and tracking mosquito individuals and swarms for counting or for initiating remedial activity. However, the invention is not limited to this context. In other embodiments other insect and non-insect pests (including rodents and other small animals and UAVs) are detected and tracked by their acoustic signatures. As used herein, swarm refers to any ensemble of multiple individuals whether or not they move in a coordinated fashion that is often called swarming behavior.

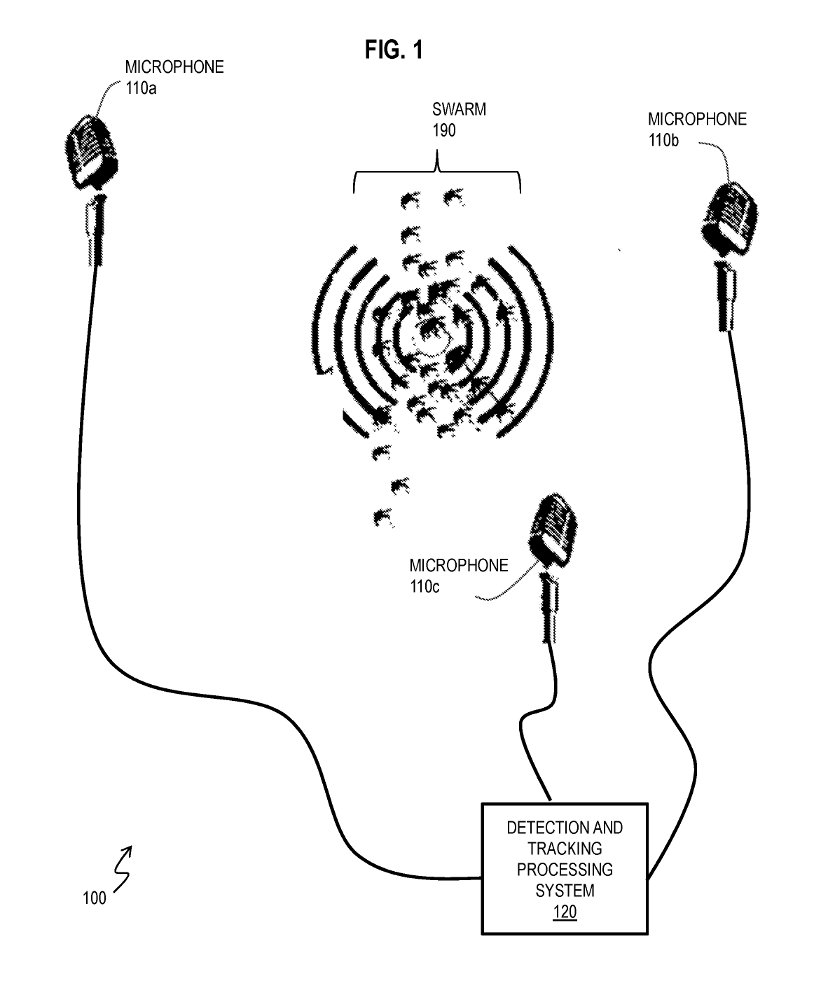

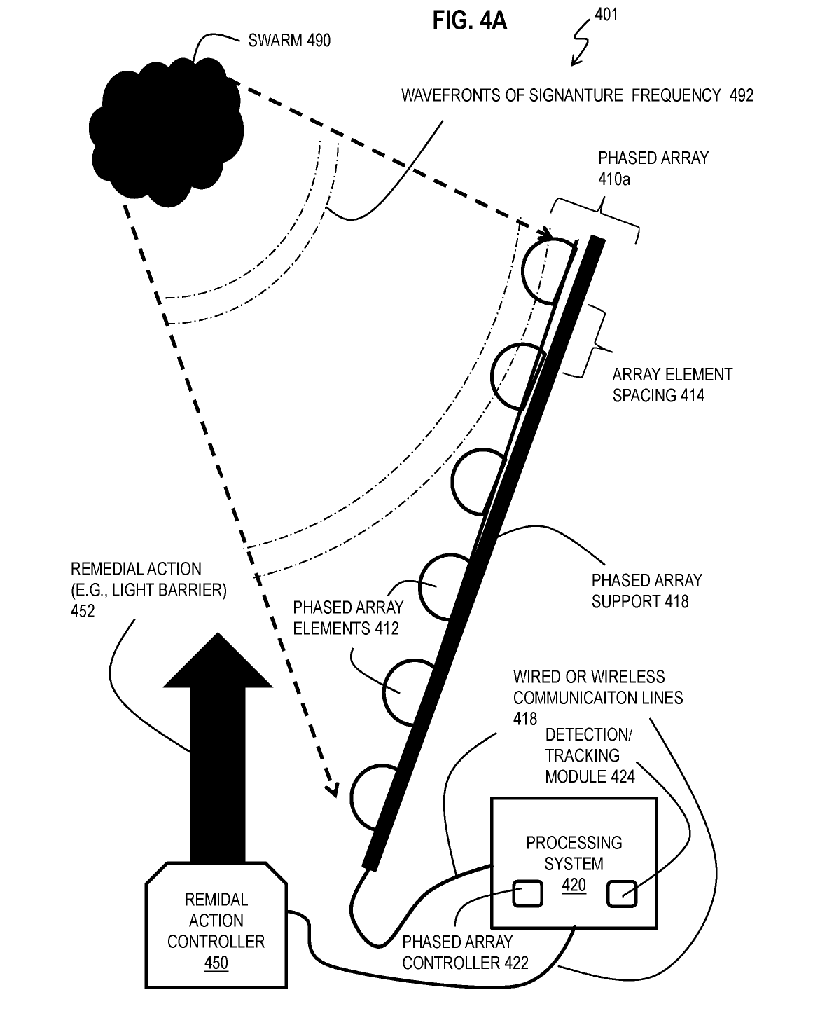

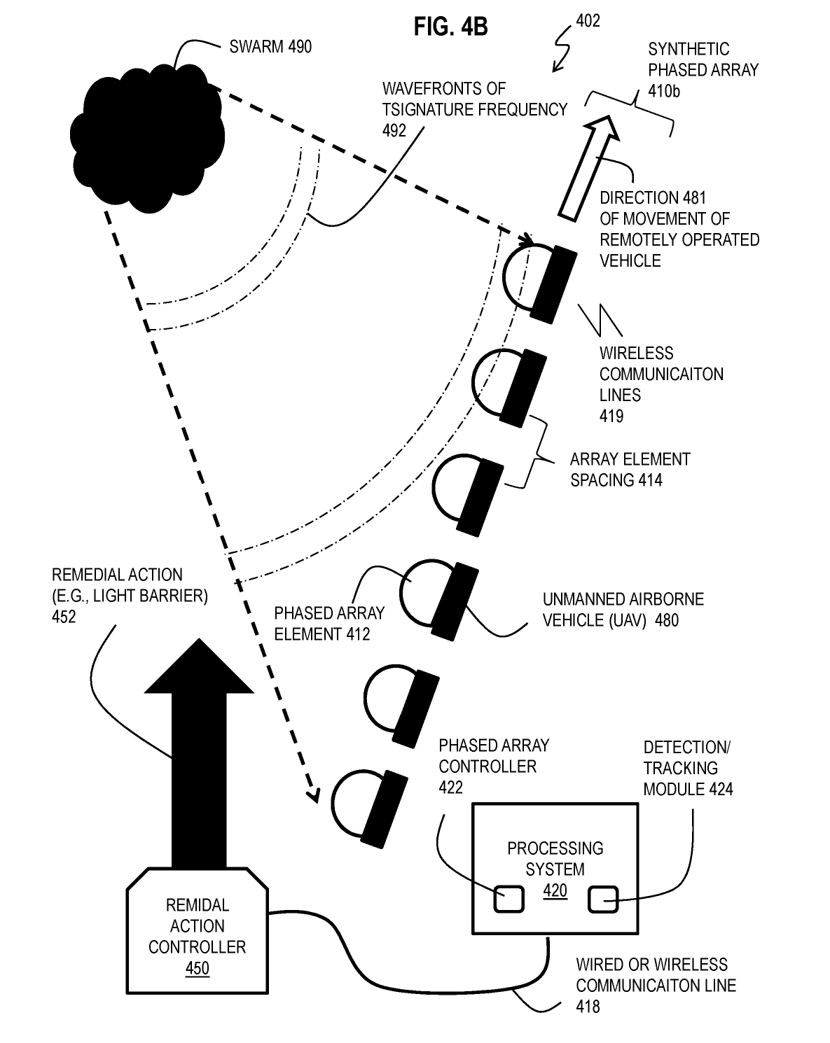

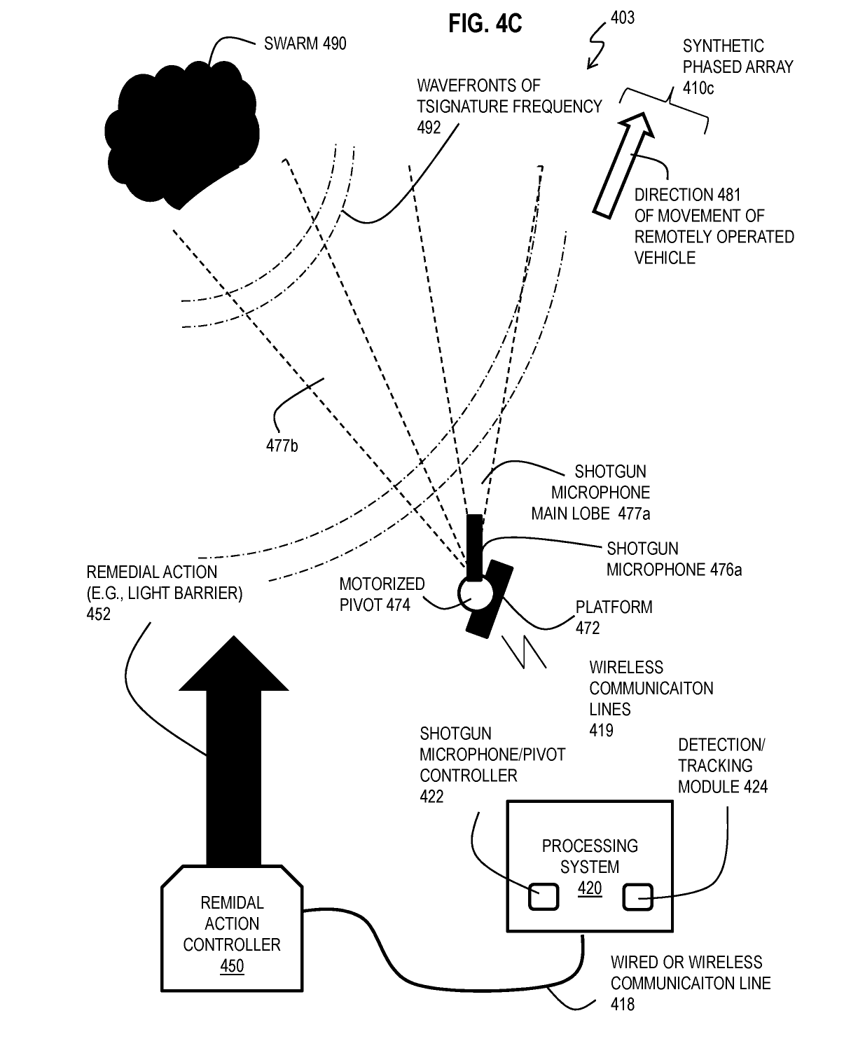

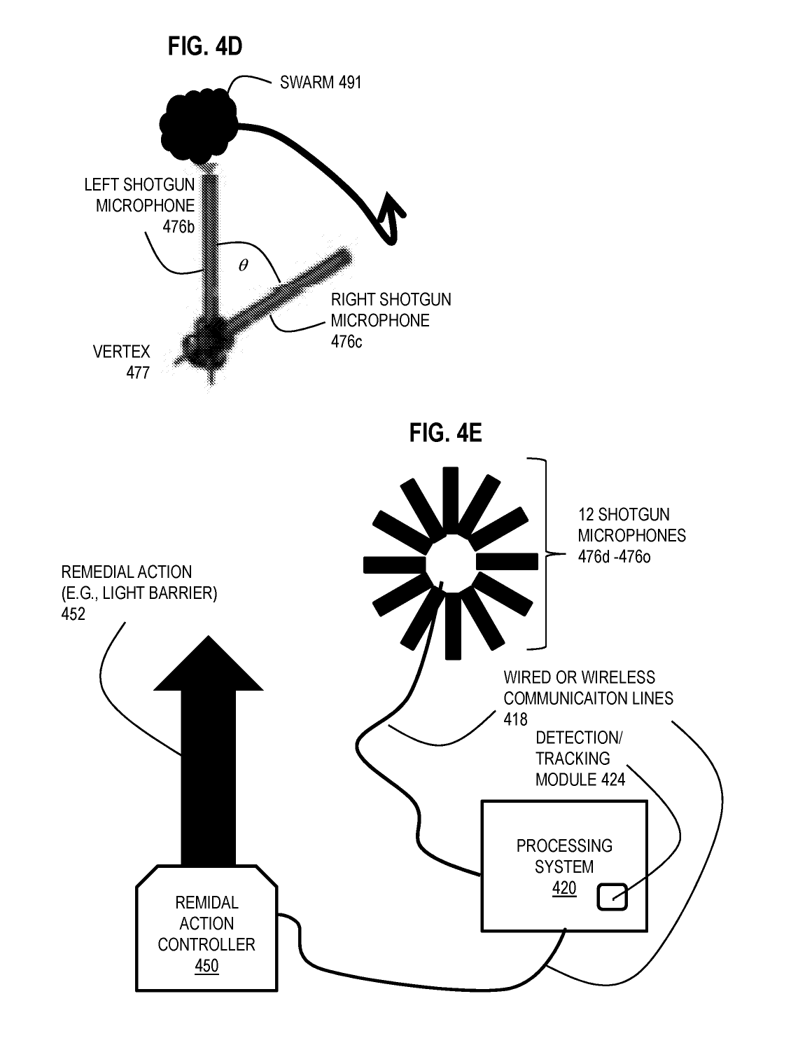

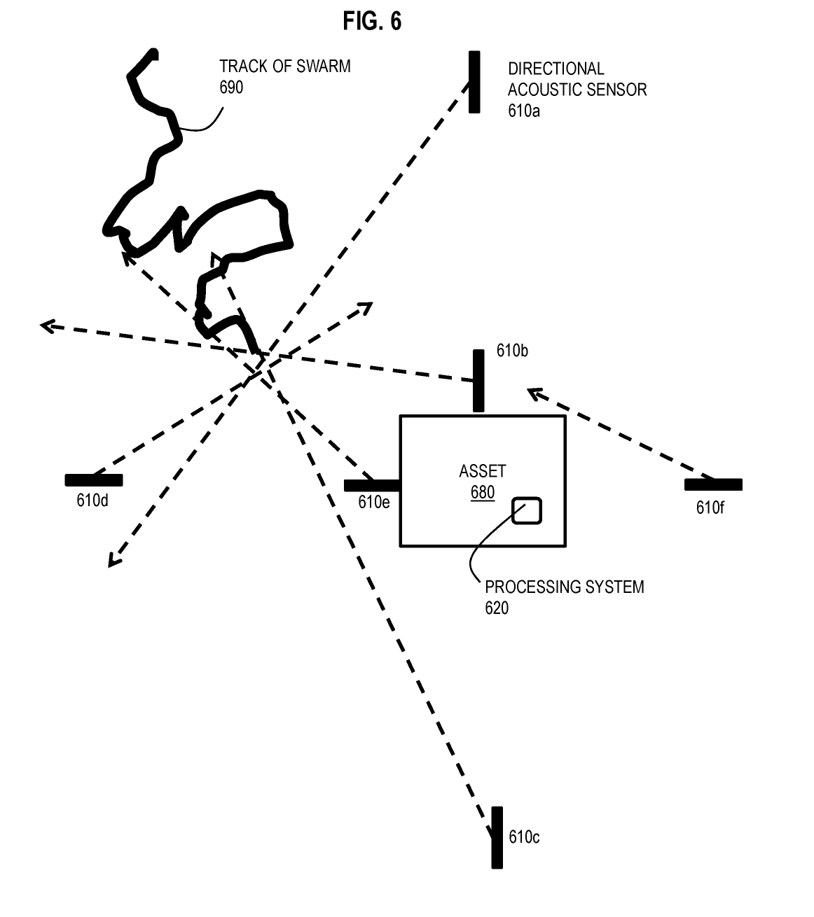

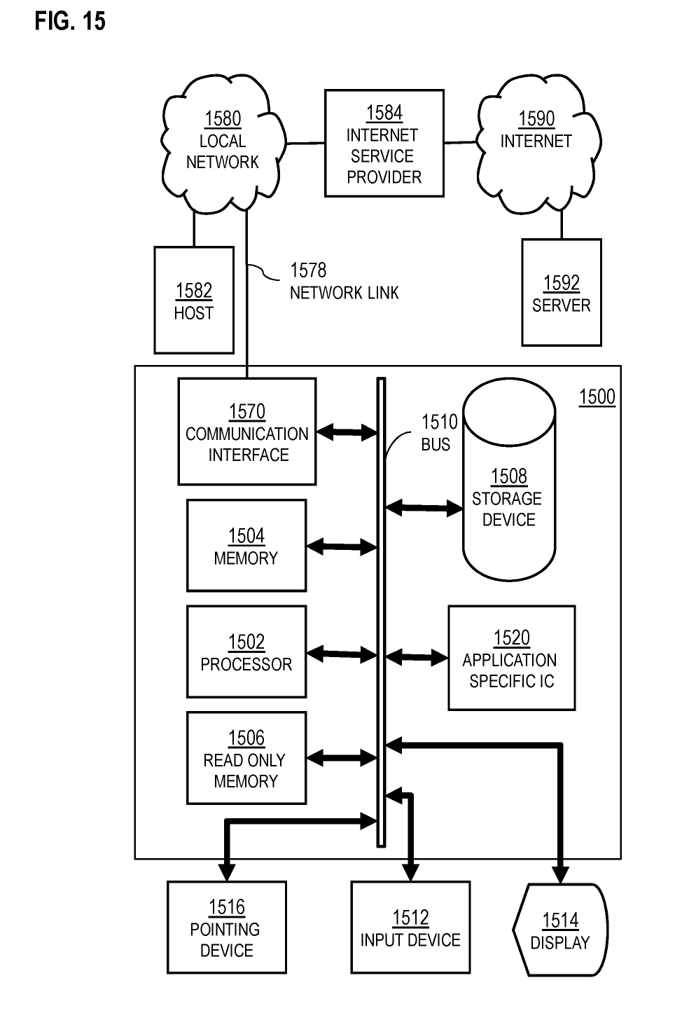

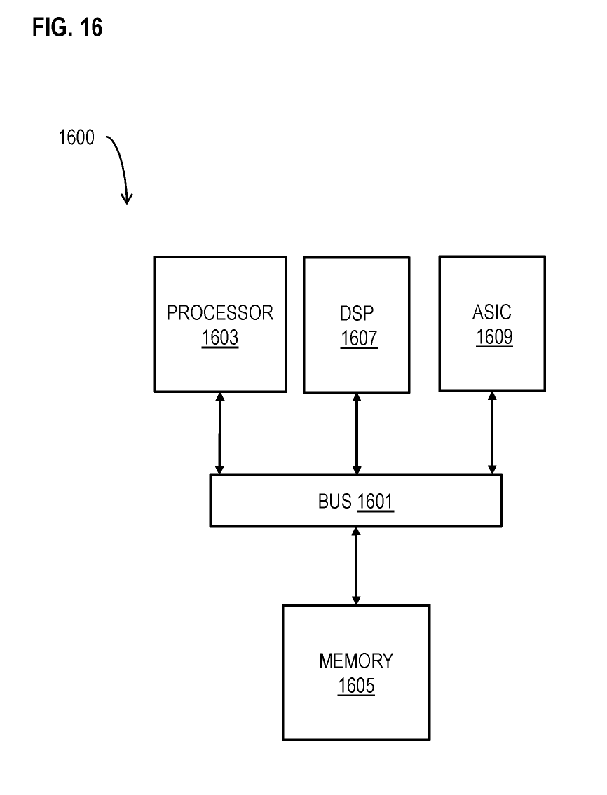

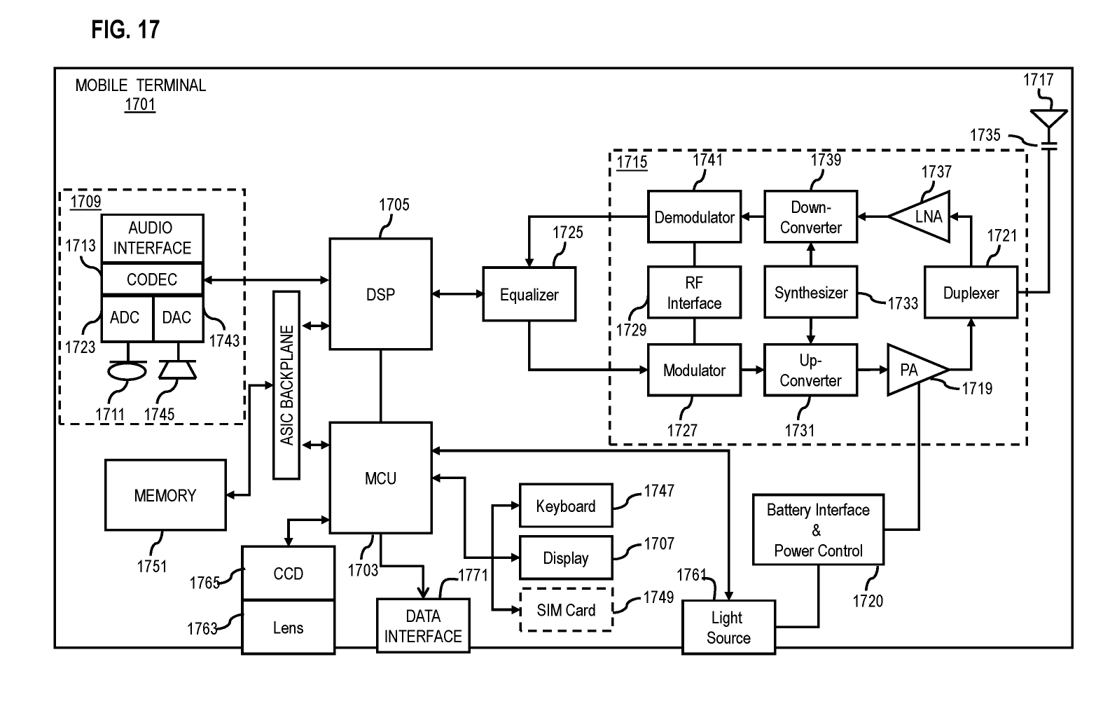

FIG. 1 is a block diagram that illustrates example system 100 in operation to locate and track a swarm 190 of insects by triangulation, according to an embodiment. Although a swarm 190 is depicted, the swarm 190 is not part of system 100. By detecting the acoustic signature of the pests in the swarm 190 at a plurality of microphones (e.g., microphones 110a, 110b, 110c, collectively referenced as microphones 110) the type pest and location of the swarm can be inferred automatically by the detection and tracking processing system 120, as described for various embodiments in the following sections. The detection and processing system 120 comprises one or more processors, such as depicted in a computer system, chip set and mobile terminal in FIG. 15, FIG. 16 and FIG. 17, respectively, described in more detail below with reference to those figures, configured with one or more modules, as described in more detail below with reference to FIG. 4A, FIG. 4B, FIG. 4C and FIG. 6.

In other embodiments, other mathematical methods for location are employed, such as multilateration and numerical approximations. Although individual pest have signatures with known characteristics, e.g., associated with wingbeats or calls, the actual waveform is not continuous but is made up of temporal changes, as the pest maneuvers or respond to environmental changes. The timing of such distinctive events will arrive at distributed microphones at different times. This information is used, in various methods, to determine direction for the source of the distinctive signal actually measured at the distributed microphones.

For example, in some embodiment, relative signal strengths and relative arrival time of events are measured through cross-correlation, auto-correlation, and root mean square (RMS) maximum computation. In some embodiments, the three dimensional (3D) space surrounding the microphone network is covered by a rough virtual grid and each 3D grid vertex is tested as a possible emitter. The grid point with the closest match to the observed delays and amplitude ratios by the microphones is selected. The 3D space around the selected 3D grid point is covered by a finer 3D grid and the most likely grid point is identified. Finer and finer grids are created recursively, converging on the most likely point of acoustic emission. The iterations are finished when sufficient accuracy is reached or when the grid is so fine that grid-points do not produce differences that are recognizable. This algorithm is very fast and robust against dynamical changes in the microphone network geometry, as long as it the microphone geometry is known at the moment of the sound recording. This is advantageous for rotating or flying microphone arrays, especially if the swarm or individual is relatively stationary compared to the moving array of microphones.

In some embodiments tracking an individual, or a known number (or estimated number) of individuals in a swarm with a continuous signal without distinctive events, the source strength of the unique acoustic signature is known, and the distance from a microphone to the individual or swarm can be estimated from the amplitude alone of the signal received at each microphone. Estimated number of individuals in a swarm can be gleaned from independent measurements (e.g., photographs), historical records and statistical analysis. In some embodiments the number of individuals can be estimated by the maximum amplitude observed over an extended time period, or frequency changes with wind speed, or fine frequency resolution.

In some embodiments, signal characteristics allows one to distinguish between cases of one, few and many, individuals in a swarm. By finding a location where the distance to each microphone agrees most closely with the estimated distance, the location of the individual or swarm center can be determined, along with a degree of uncertainty in the location, by the system 120 automatically. For example, frequency bandwidth of acoustic signals from an individual are relatively narrow over a short time and can change substantially over time as the individual maneuvers. The broader the frequency peak in the short term the more individuals are contributing. Gradually, at large numbers of individuals, the signals include broad peaks that remain relatively homogeneous over time.

In some embodiments, each microphone 110 is a directional microphone and is configured to be pointed in different directions. By pointing each microphone in a direction of maximum amplitude of the known acoustic signature of the pest, the location where the direction of the microphones most closely converge is taken as the estimated location of the individual or swarm with a degree of uncertainly estimated based on the distance between points of convergence. An advantage of this embodiment is that the signal can be continuous without discreet events and the number of individuals in the swarm need not be known or estimated a priori. Indeed, after the location is determined, the distance to each microphone can also be determined and, as a consequence, the number of individuals in the swarm can be estimated a posteriori by the system 120 automatically. A further advantage is that the noise in the main lobe of the directional microphone is less than the noise detected in an omnidirectional microphone. Still further, the directional microphones can be disposed to point in directions where the noise is expected to be less, e.g., downward where there are few sources, rather than horizontally where there are many potential noise sources.

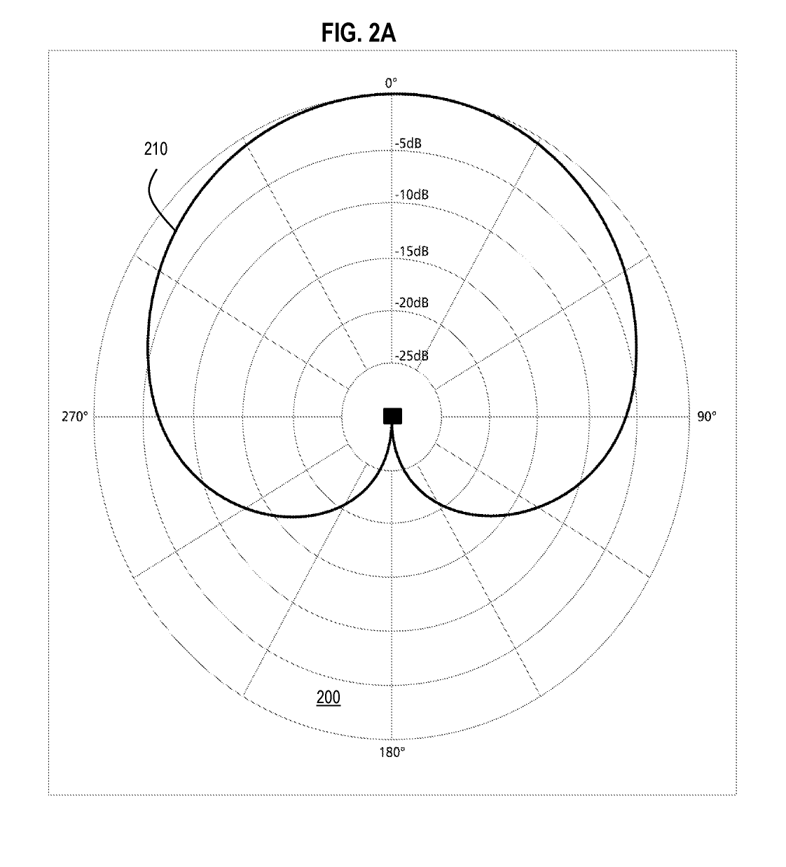

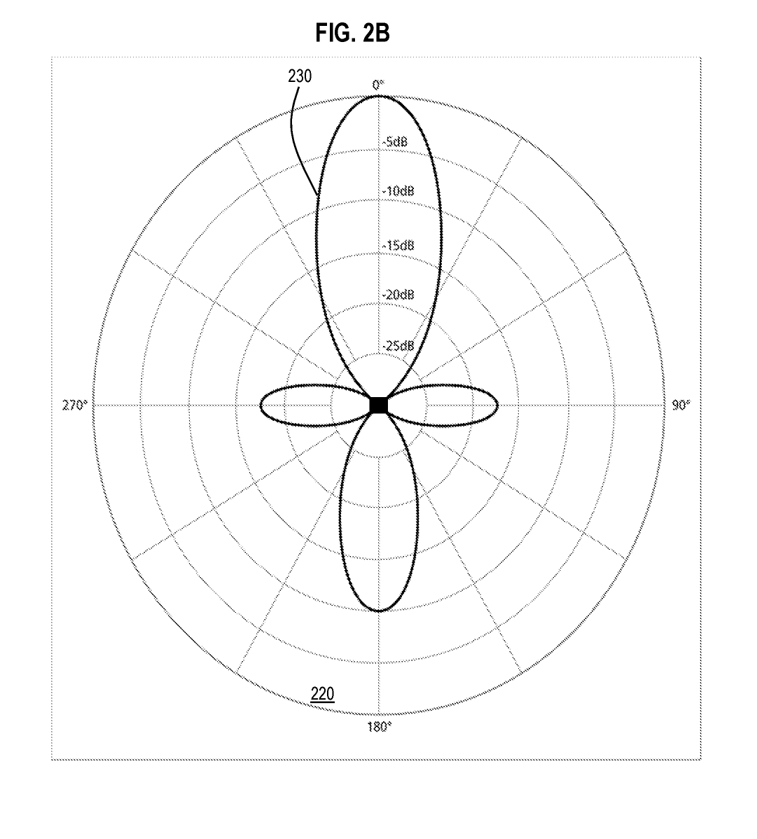

Microphones are available with different directional responses, including omnidirectional, bi-directional, sub-cardioid, cardioid, hyper-cardioid, super-cardioid and shotgun. FIG. 2A is a graph that illustrates example directional microphone with cardioid response for use in a system to locate and track an individual or swarm of pests, according to an embodiment. FIG. 2B is a graph that illustrates example directional microphone with shotgun response for use in a system to locate and track an individual or swarm of pests, according to an embodiment. Parabolic microphones can also be used with an unambiguous narrow directional response. Specific commercially available microphones used in various embodiments include CAD Equitek E100S Supercardioid Condenser Microphone, Tascam TM-80 Studio Condenser Microphone (×4), Senal MS-77 DSLR/Video Mini Shotgun Microphone (×2), Rode VideoMic GO Lightweight On-Camera Microphone, Vidpro XM-88 (this came in 13-Piece Professional Video & Broadcast Unidirectional Condenser Microphone Kit, Apple iPhone 5 32 GB built-in microphone. A parabolic microphone was constructed by mounting a CAD Equitek E100S Supercardioid Condenser Microphone on a DirecTV International World Direct Satellite Dish DTV36EDS.

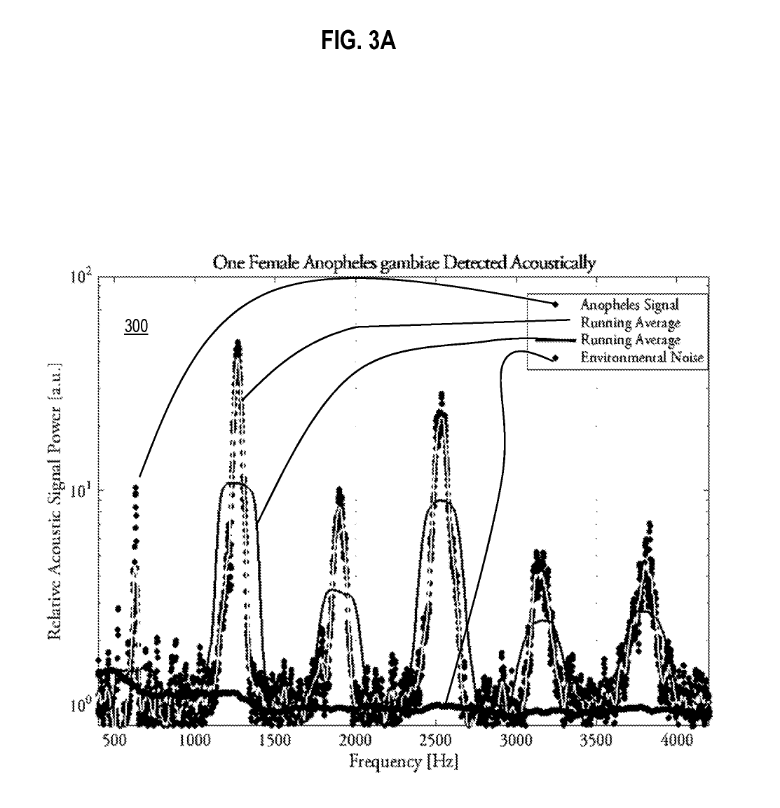

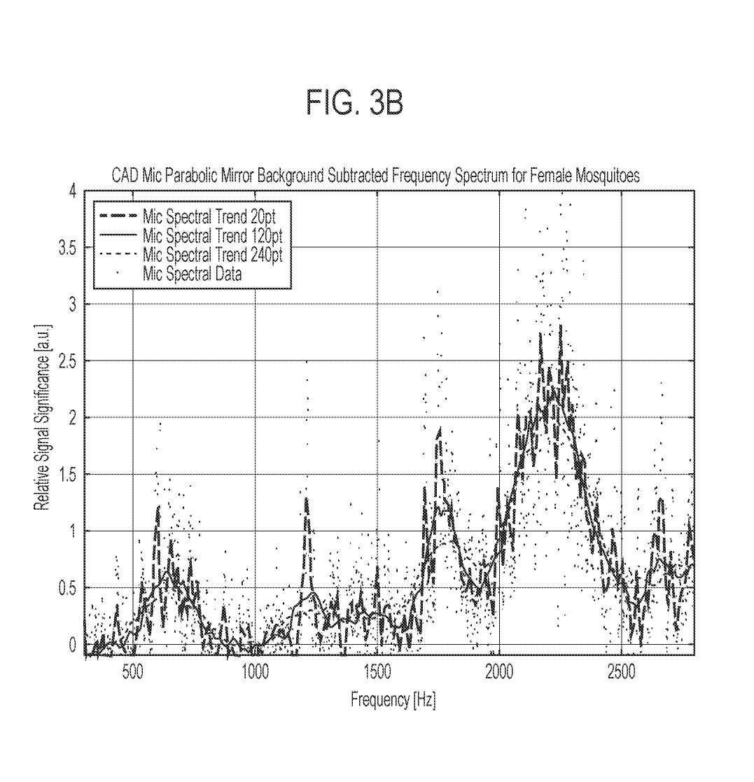

FIG. 3A is a graph that illustrates example acoustic signature of a female Anopheles gambiae mosquito for use in a system to locate and track an individual or swarm of pests, according to an embodiment. The plot is a frequency spectrum and black dots represent computed spectral values. The time domain data was divided into time slices with 50% overlap. Each time slice was Fourier transformed. The average background distribution was also computed for data taken earlier with the same microphone in the same setting. For each frequency the appropriate value from each time slide's frequency spectrum was summed up creating the frequency spectra shown. A base signal is indicated at about 630 Hz to 650 Hz and harmonics are seen at various multiples thereof. The bandwidth of each successive harmonic increases slightly as well. This data depicts the acoustic signature of one of the rare small females with unusually high frequency. Most females are significantly lower than this. Summarizing much of the original data collected in various embodiments, the female of this species is characterized by a base band centered at about 560 Hz, with a bandwidth of +/−50 Hz, while the male is characterized by a base band centered about 840 Hz, with a similar bandwidth of +/−50 Hz. Thus, there is a noticeable gap in the acoustic signatures of the two genders from about 610 to about 790 Hz in the base band. Harmonics multiply both the center and the bandwidths. It is useful to note that much (but not all) of the literature frequency data is on tethered mosquitos, not freely flying mosquitoes in a netted cage, as measured here.

Other frequency signature variations occur among individuals including some changes with age, size and fitness. In general, for this species, the first harmonic is between 500 Hz and 900 Hz with about 100 Hz bandwidth for an individual. The females are characteristically in the lower half while the males are in the upper half of this frequency range. Then the second harmonic between 1000 Hz and 1800 Hz will have a 200 Hz bandwidth for an individual. The wing strokes are also extremely complex movements, so for different flight maneuvers different harmonics can be emphasized. The graph indicates that a single microphone can distinguish the sound of a single female Anopheles gambiae mosquito from the background environmental noise with significant signal to noise ratio. The area above the noise trace and below the first running average trace is useful signal above background. The black dots and closest running trace show the acoustic frequency harmonics due to the wingbeats of the mosquito. The lowest trace is the spectrum of the laboratory noise recorded without mosquitos present in the same single microphone setup. Such spectra can be recorded for every time interval to create time dependent Fourier spectra, called a spectrogram. For each time interval, the area under the peaks and above the background trace can be recorded, signaling the presence of a mosquito. For multiple mosquitoes the signals add up. The broader but decreased peak running average trace is simply there to guide the eye. In some embodiments, the signature signal to noise ratio is increased by combining the signals in the base frequency band and one or more harmonic bands. Substantial signal harmonics are evident even in the very noisy conditions of this experiment conducted in a city environment. In some embodiments, the signal is represented by the sum of the peaks above the noise floor.

FIG. 3B is a graph that illustrates an example spectrum of data collected with a parabolic microphone, according to an embodiment. This graph depicts the frequency spectrum of a mosquito ensemble taken from 18 feet away with the CAD microphone mounted on the parabolic dish. The higher frequencies are emphasized as this setup enhances those higher frequencies. The first and second harmonics of multiple individuals are resolved even at this distance.

FIG. 4A is a block diagram that illustrates example use of an acoustic phased array 410a in a system 401 to locate, track and take remedial action against an individual or swarm of pests, according to an embodiment. Although swarm 490 and wavefronts of signature frequency 492 are depicted for the purposes of illustration, neither is part of system 401. In this embodiment a phased array 410a of multiple elements 412 are mounted to a support 418 and separated by a constant or variable array element spacing 414. Each element is an omnidirectional or a directional microphone 110. An acoustic beam impinging on the phased array 410 at a particular angle will have acoustic wavefronts 492 that strikes the various elements with waveforms at successive times that depend on the sound speed, angle and spacing 414 blurred by the size of the swarm, the accuracy of the microphone locations and the accuracy of the microphone pointing directions. The wavelength and signature frequency are related by the speed of sound in air which is a strong function of temperature, humidity and pressure, but is approximately 340 meters per second under some typical conditions. By combining the contributions at successive elements delayed by the time for an acoustic wavefront to arrive at those elements at a particular arrival angle for the local sound speed, the contributions from one direction can be distinguished from the arrivals at a different direction according to the well-known principles of beamforming. The time series of arrivals at each angle can be Fourier transformed to determine the spectral content of the arrival. Based on the spectral content, it can be determined whether the signal includes the signature of the pest of interest.

Originally, the combination was performed by summing for hardware implementations where the search was implemented via wires and delay lines. Nowadays, digital phased array techniques are implemented as the processing is fast enough. For example an algorithm includes the following steps. The full data is recorded at each microphone (or sub array connected in hardware). The excess power algorithm outlined above is executed at each microphone to extract excess power based trigger of mosquito activity. If any of the detectors signals mosquito activity (usually the closest one) then the pairwise correlation between microphones are computed determining relative time delays and amplitude ratios between the sensing elements of the array. The information is combined either via trigonometry or the numerical approach e.g. the one outlined above to determine the 3D position of the emitter. Since each time slice gives a 3D position, the successive 3D positions provide a trajectory for a moving source or a successively refined position for a stationary source.

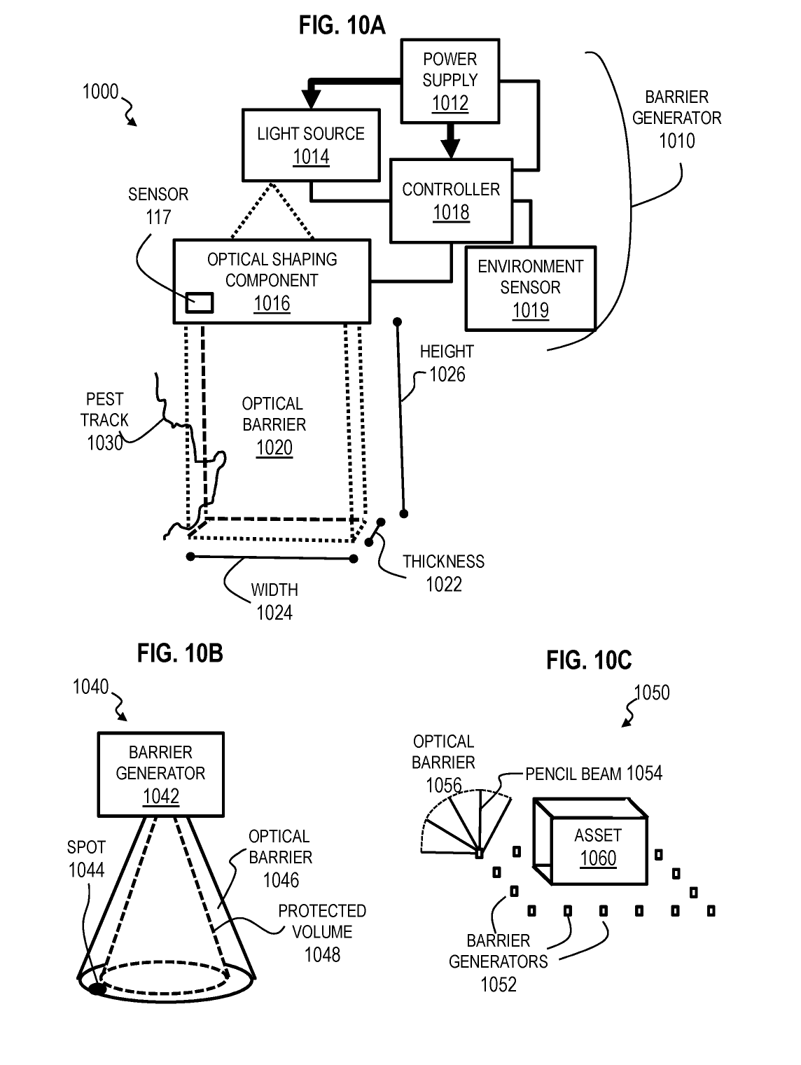

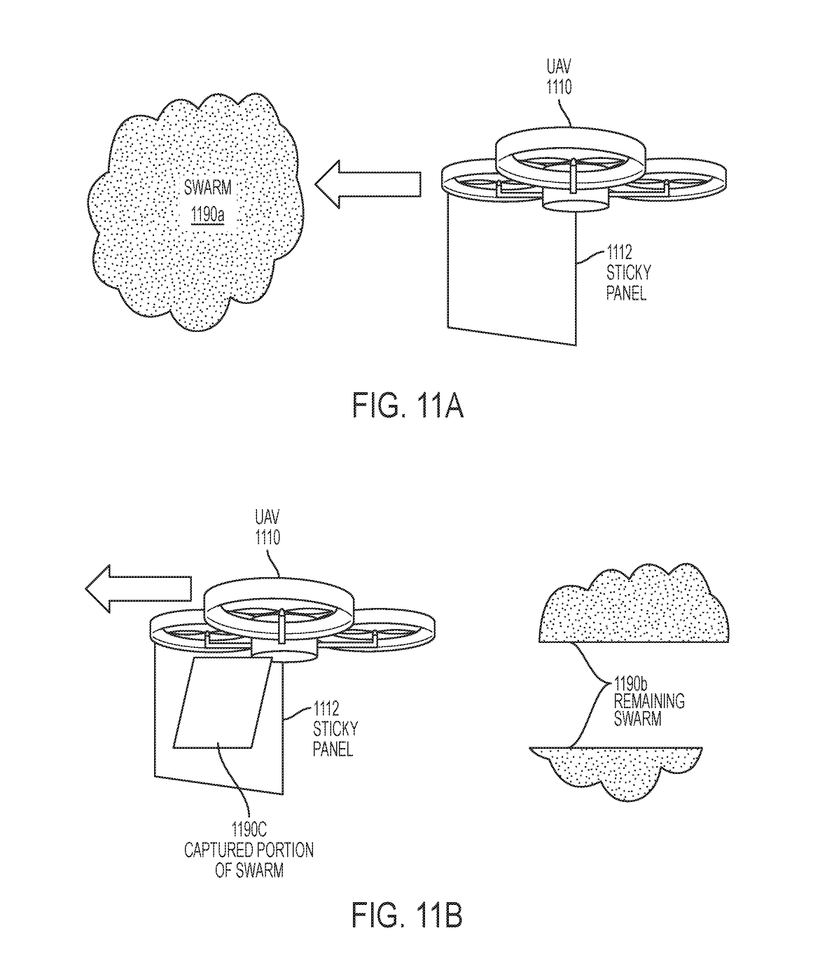

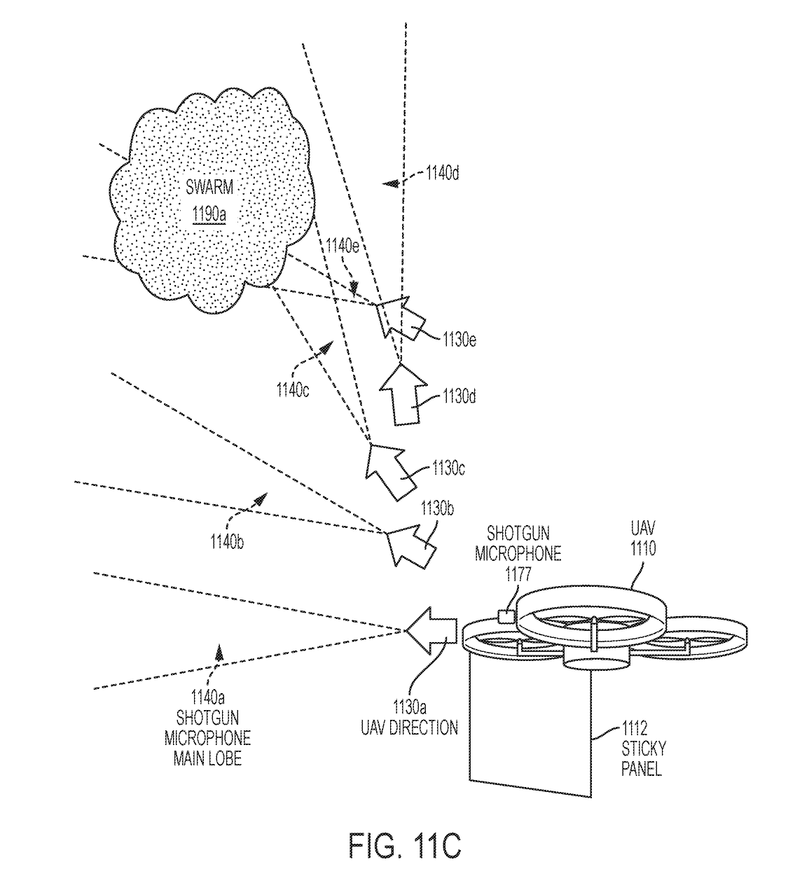

Processing system 420 includes a phased array controller module that is configured in hardware or software to do the beamforming on the arriving signals. The processing system 420 includes a detection and tracking module 424 that determines which direction is dominated by the acoustic signatures of a pest. Based on the direction from which the acoustic signatures of the pest are arriving, the module 424 causes one or more remedial action controllers 450 to deploy some remedial action 452. In some embodiments the remedial action is to activate an optical barrier, as depicted in one of FIG. 10A through FIG. 10C, described in more detail below with reference to those figures. For example, if the acoustic signatures of the pest are arriving at an angle on a first side of an asset, then an optical barrier is activated on the first side of the asset. In various other embodiments, the remedial action is to sound an alarm, deploy a pest killing device, such as a laser or mechanical device, or activate a capturing device (trap), or mark the pest, e.g., with a fluorescent dye, or increment a count, or release sterile males, among others, or some combination. In some embodiments, the remedial action involves a UAV, also called a drone hereinafter, as described in more detail below with reference to FIG. 11A through FIG. 11C.

FIG. 4B is a block diagram that illustrates example use of a virtual (or synthetic) acoustic phased array 410b in a system to locate, track and take remedial action against an individual or swarm of pests, according to an embodiment. In this embodiment, the multiple array elements 412 on a support 418 are replaced by fewer array elements (e.g., one or more) on a UAV 480. The flight of the UAV 480 in direction 481 constructs a virtual or synthetic phased array 410b. The signals are combined as before, but in this embodiment taking account of the flight time of the vehicle 480 between locations of the virtual elements (indicated by successive positons of a single UAV 480 in FIG. 4B). One can treat the UAV as a stationary microphone array, because the swarm tends to be more stable in location than the UAV. When a single drone makes multiple observations at different times long compared to an inverse of the frequency, the multiple observations can be interpreted as a non-phased array. In some embodiments, multiple UAVs working together form the phased array 410b.

FIG. 4C is a block diagram that illustrates example use of a highly directional microphone (e.g., a shotgun microphone) in a motorized pivot in a system to locate, track and take remedial action against an individual or swarm of pests, according to an embodiment. The platform 472 can be a UAV or a stationary support structure, such as a pole, kite, tethered balloon, or tripod. On the platform 472 is mounted a motorized pivot 474 that can be rotated with one, two or three rotational degrees of freedom (DOF). Mounted on the pivot 474 is a directional microphone, such as a shotgun microphone 476. As the pivot moves, the main lobe of the response of the shotgun microphone sweeps through different angels. For example, at one time, the shotgun microphone main lobe 477a is pointed in a first direction and at another time the main lobe 477b is pointed in another direction. When pointed at the individual or swarm 490, the signal strength is greatest and the direction to the individual or swarm is thus determined.

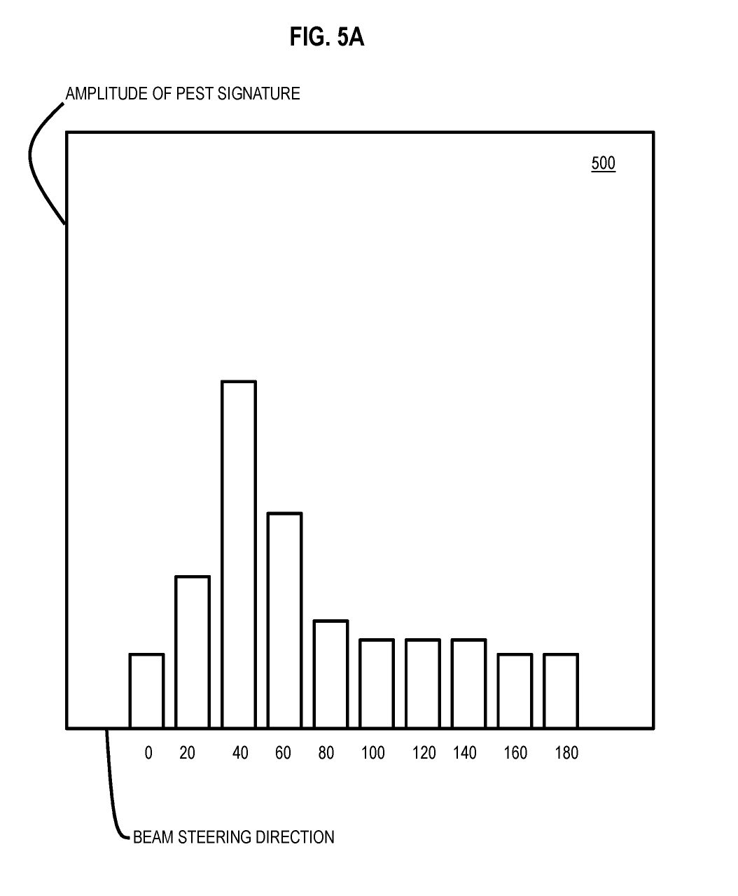

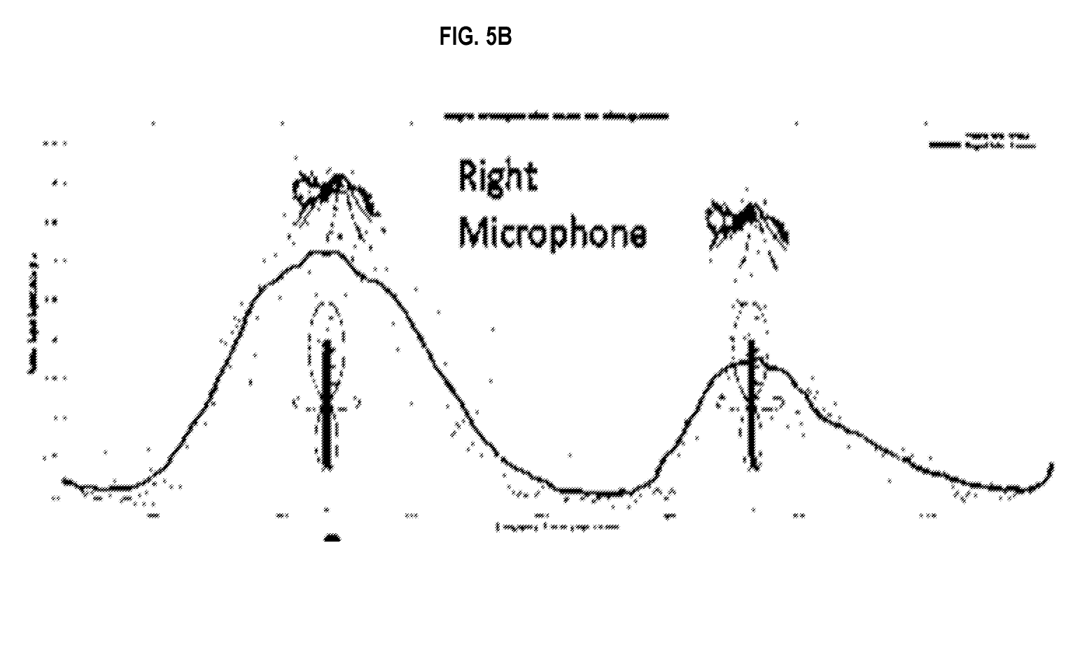

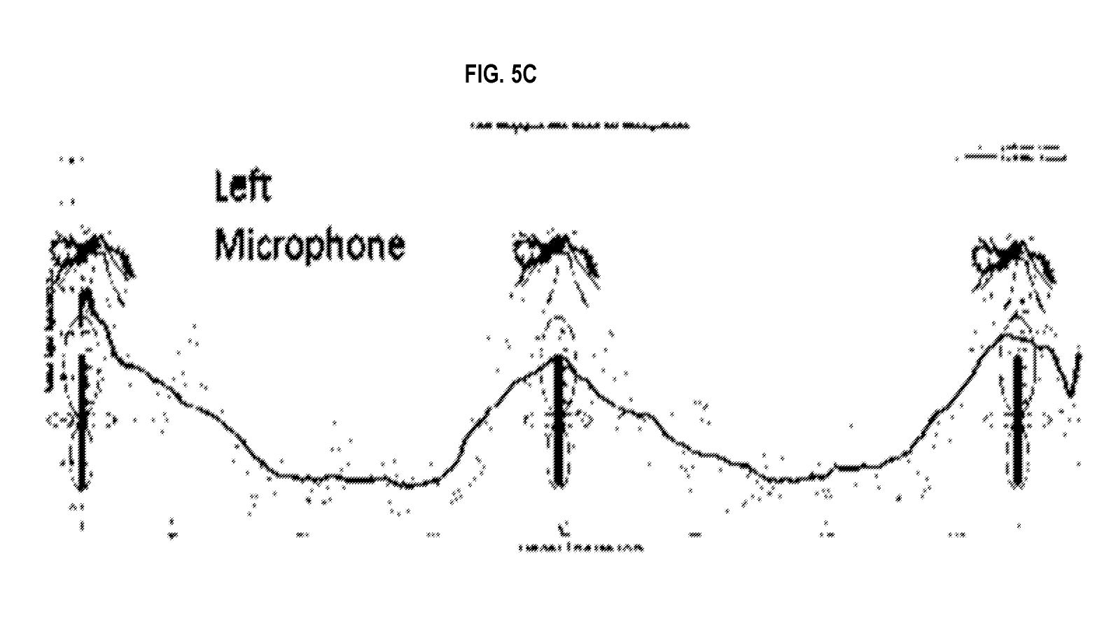

FIG. 4D is a block diagram that illustrates example use of a pair of shotgun microphones to locate, track or take remedial action against an individual or swarm of pests, according to another embodiment. The pair includes a left shotgun microphone 476b and a right shotgun microphone 476c oriented in different directions from vertex 477, separated by an angle θ. In various embodiments, the two microphones are fixed relative to the ground and each other (e.g., no pivoting mechanism); are mounted to a single pivoting mechanism so that the angle θ between the two microphones remained fixed, but the pair can be rotated together; or mounted on separate pivoting mechanisms so that the angle θ between them can be changed as well, varying from zero up to 180 degrees. In an experimental embodiment for which data are presented below with respect to FIG. 5B and FIG. 5C, the microphones are fixed with respect to the ground, both pointed in a horizontal plane with a fixed directional difference θ of 60 degrees.

FIG. 4E is a block diagram that illustrates example use of twelve shotgun microphones (476d through 476o at positions corresponding to analog clock face positions 1 through 12, respectively) are pointed 30 degrees apart in a system to locate, track and take remedial action against an individual or swarm of pests, according to another embodiment. In other embodiments more or fewer shotgun microphones are configured at smaller or greater, equal or unequal, angular separations. In some embodiments, 12 microphones 476d through 476o tracking a single mosquito or swarm can provide angular resolution for the target of about 1 degree as the amplitude of the target reaches a maximum with each main lobe.

FIG. 5A is a graph that illustrates example directional data from beamforming signals received at a phased array or from a highly directional microphone, according to an embodiment. The amplitude of the acoustic signature of the pest of interest is determined for each of multiple pointed or beam-formed arrival angles, with a directional resolution of 20 degrees in this example. As can be seen, the amplitude is greatest at 40 degrees, implying a direction to the individual or swarm of about 40 degrees. Because the directional pattern of the microphone and processing system is known, the histogram can be fit with the microphone response to determine the direction to a much higher precision than 10 degrees if desired.

In an experimental embodiment, an ensemble 491 of Anopheles gambiae mosquitoes were placed about 20 inches from the vertex 477 of the two fixed shotgun microphones 476b and 476c. The ensemble was situated in a cage made up of walls made of netting. Not all mosquitoes were flying; some were resting on the mosquito netting wall of the cage. The ensemble 491 was moved in an arc back and forth around the vertex of the microphones. Therefore in one of the microphones the signal was maximized when that microphone was pointing to the center of the ensemble. Coincidentally, the signal was minimized in the other microphone at that time. Therefore when the mosquito ensemble was moving between the optimal directions (centers of main lobes) of the two microphones, the signal strength was rising and falling out of phase between the microphones. FIG. 5B and FIG. 5C are graphs that illustrate example experimental data using the system of FIG. 4D, according to an embodiment. The signal included multiple harmonics between 300 Hz and 3300 Hz. The vertical axis indicates integrated signal strength for all relevant frequencies between 300-3300, including the first harmonics; and, the horizontal axis covers about 80 seconds of observation time from time=40 seconds to time=120 seconds.

The ensemble (test swarm) is within the main lobe of the left microphone at about times 45, 80 and 115 seconds; and, within the main lobe of the right microphone at about 65 and 95 seconds. The dots indicate individual observation and the solid trace indicates the running average of 101 points centered on the displayed point. The trace is hundreds of noise standard deviations above the noise level. FIG. 5B shows the signals from the right microphone and FIG. 5C shows the signals for the left microphone. Note that since the sensitivity patterns of the microphones don't overlap in direction, the curves are complementary to each other, i.e., either one or the other microphone sees the mosquitoes. The trace determines the relative direction of the mosquitoes at high degree of precision on the order of a degree. Therefore a single rotating shotgun microphone can rapidly pinpoint the direction of the mosquitoes and a 12 shotgun microphone assembly with shotgun microphones pointed at 30 degrees separation from each other (as depicted in FIG. 4E) can monitor the full horizontal plane with little or no rotation. The difference in maximum signal level between the returns of the ensemble to a microphone's main lobe, e.g. between the peaks in FIG. 5B, indicate that the number of flying mosquitoes in the ensemble has changed. In other embodiments, such an amplitude change could indicate a flying swarm has either moved to different distances from the microphone or did not enter the center of the main lobe. Note that the peak in FIG. 5B at 95 seconds is lower than the peak at 65 seconds, indicating the ensemble included fewer flying mosquitos. After the initial excitation, as time goes ahead, more and more mosquitoes will settle down. So in this case the second peak is smaller because the simulated swarm became smaller. In a natural swarm the number of flying insects remains much more constant; and, direction or range can be inferred.

In these plots, only the amplitude of the signal is used, however the relative phase of the signal in neighboring microphones carry additional information. As described above for the phased arrays, a network of omnidirectional microphones can electronically shape and steer the sensitivity pattern of the array, therefore providing the equivalent of a physically rotating directional microphone. Sometimes electronically achieved rotation can be superior in robustness to physical rotation.

Multiple geographically separated directional or arrays of microphones with overlapping sensitive range can cover an area and each directional microphone or array can supply direction(s) to the mosquitoes. Since the locations of the stationary or airborne microphones are known, the directions provide a location for the mosquitoes. FIG. 6 is a block diagram that illustrates example use of multiple phased arrays or directional microphones 610, or some combination, in a system to locate, track and take remedial action against an individual or swarm of pests, according to an embodiment. By combining the direction information of an individual or swarm or pests from multiple arrays or directional microphones 610a through 610f, a region of intersection can be determined. A position within the region, such as the centroid, is taken as the location of the individual or the center of the swarm, and the size of the region of intersection is taken as the uncertainty of the location or the size of the swarm or some combination.

The time series of such positons constitutes a track 690 of the swarm or individual. Based on the location of the swarm and its approach or retreat from an asset 680, such as a person, a dwelling or a crop, it is determined whether to deploy some remedial action. In this embodiment, the directional information from all the arrays or directional microphones 610 are used by a detection and tracking module (e.g., 424) executing on processing system 620.

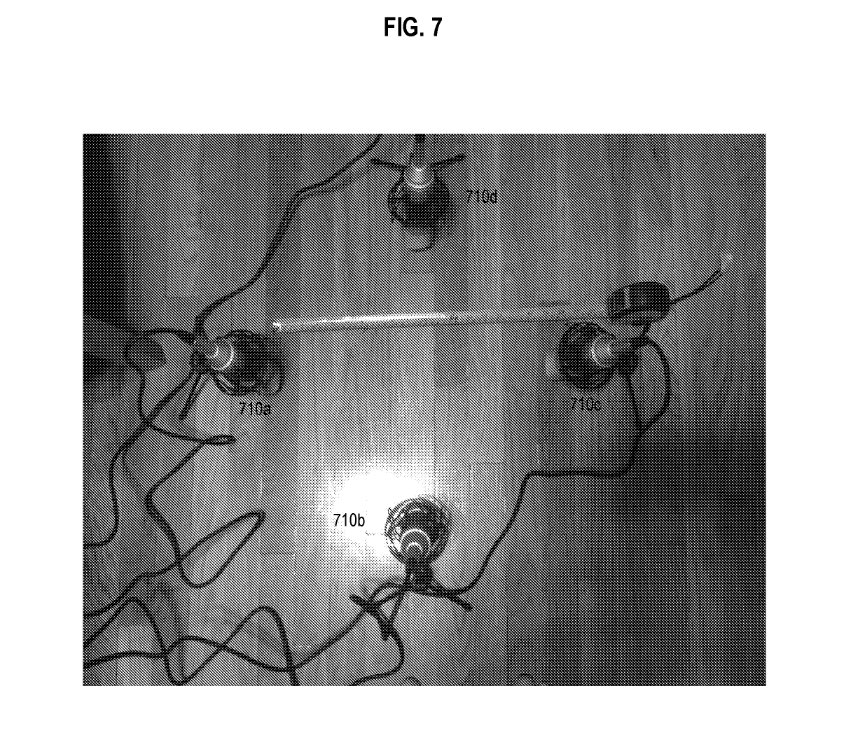

One can record slight changes in the mosquito's flight mode, as even small changes in the characteristic frequencies can be recovered from the high-signal-to-noise ratio Fourier spectrum. FIG. 7 is a photograph of an example experimental setup to detect unique acoustic signatures of a pest, according to an embodiment. Four Tascam TM-80 Studio Condenser microphones 710a through 710d (collectively microphones 710) are arranged for triangulation. Each microphone 710 is selected from the omnidirectional or directional microphones 110 described above. The microphones were set up at corners of a square with a 21 inch diagonal spacing.

When an array of identical microphones are collecting data in a way that their signal is sampled simultaneously, one can use the relative amplitude and arrival phase of the signals to locate and track the emitter in 3D. For example, when 2 microphones hear the same emitter the relative arrival phase of the signal at the 2 microphones will be different, largest when the emitter is along the line connecting the microphones and smallest when the emitter is halfway between the microphones. Two microphones will give one angle, 3 microphones will give 2 or 3 angles, 4 microphones will give 3 or 4 angles, and so on as long as the baselines connecting the various microphone pairs are not co-linear. For a microphone array of well known geometry, the relative signal amplitudes can also provide directional and distance information, e.g., the signal is weaker in microphones that are farther away from the source. Of course when using directional microphones, computation gets more complicated, but the basic idea is the same. Experimental data shows that one can recover both the signal amplitude and phase with a microphone array. The example data is for a UAV, but the same approach is obviously applicable for a single mosquito too. Phase information will be useful for swarms too, but differently from individuals. When there is a wind gust, the individuals in the swarm tend to compensate in unison to remain above the marker, and that change will occur in-phase.

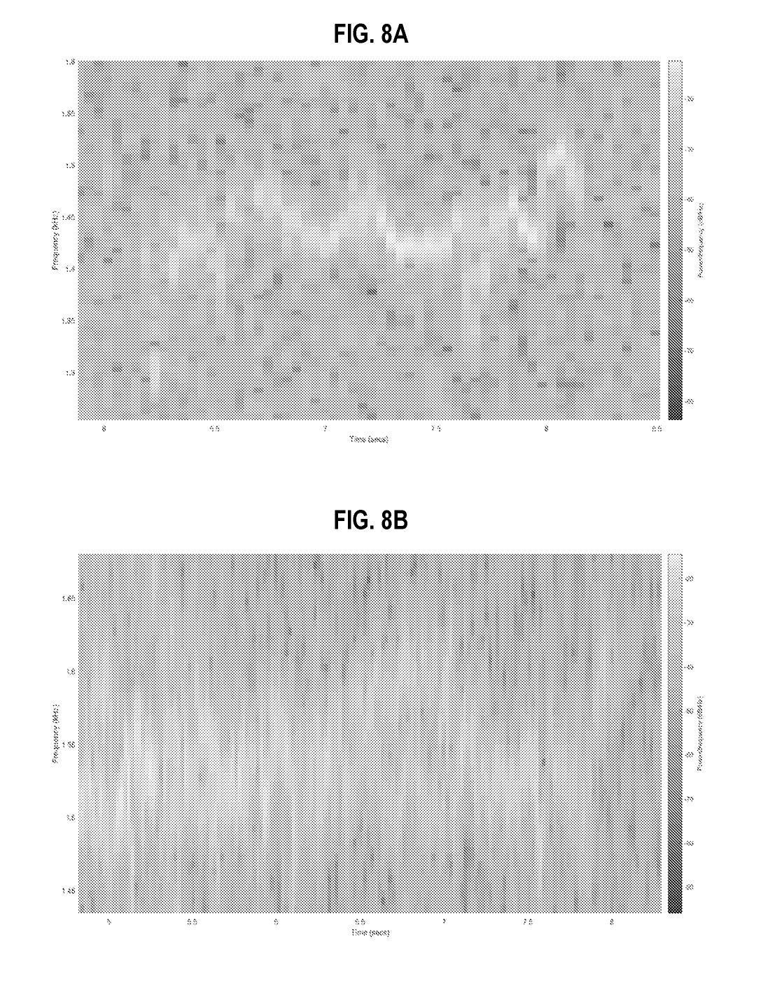

FIG. 8A and FIG. 8B are graphs that illustrate example spectrograms that display unique acoustic signatures of an individual and swarm, respectively, according to various embodiments. The Fourier spectrum is shown as a function of time. The spectrum is calculated over small parts of the recorded sound, and the resulting magnitudes plotted as a function of time. The lighter pixels represent the largest magnitudes. In FIG. 8A, the spectrogram of an individual mosquito acoustic signature on its second harmonic is plotted. The horizontal axis is time and the vertical axis is frequency. One can see that the reconstructed peak frequency changes in time as the insect slightly changes its flight. Specifically, one can observe that as the mosquito is executing complex flight maneuvers inside the quite small (10 cm×10 cm×10 cm) cage to avoid the walls and as it accelerates or decelerates the wingbeat frequency changes slightly, e.g., moves up and down for consecutive time slices. In FIG. 8B, the spectrogram of mosquito ensemble (swarm) acoustic signature on its second harmonic is plotted. The horizontal axis is time and the vertical axis is frequency. One can observe that the trace is quite wide as the mosquitoes are executing complex flight maneuvers inside the quite small (10 cm×10 cm×10 cm) cage to avoid the walls and as they accelerate or decelerate the wingbeat frequency change slightly, e.g., moves up and down for consecutive time slices. The variations among individuals tend to broaden the peak but also tend to cause the overall spectrogram to remain more homogeneous over time. A light band of peak frequency tiles is seen as the contributions from individual mosquitoes add up. Signals are strong above the noise in the experiment at ranges of one foot. It is anticipated that one can feasibly gain factor of 100 in reducing microphone noise, at which point the data acquisition system and environmental noise will start dominating. Thus a range of over 10 feet for detection of an individual mosquito is feasible. A mosquito ensemble comparable to small swarms was clearly visible from 18 feet with a CAD Mic on a Parabolic dish. With better microphone noise and sensitivity this distance for swarms can improve by even a factor of 10 for swarm detection on the order of 180 feet

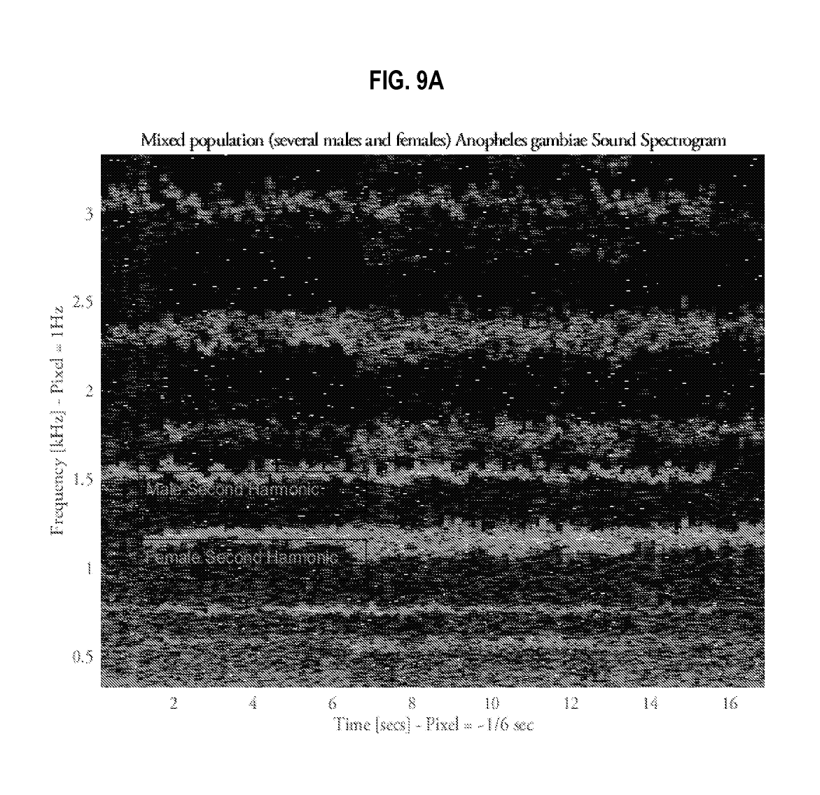

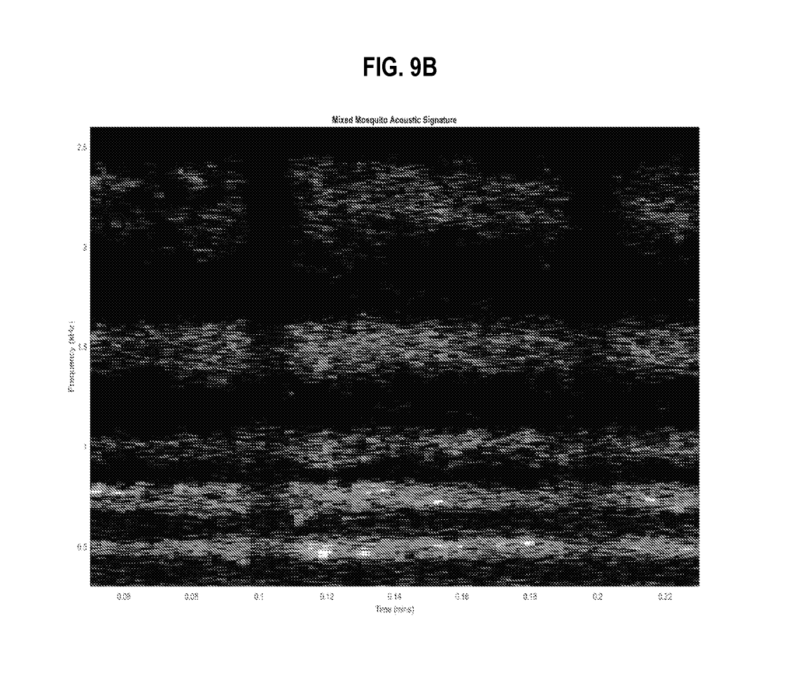

FIG. 9A and FIG. 9B are graphs that illustrate example spectrograms that display unique acoustic signatures of an individual male and individual female on various scales, respectively, according to one embodiment. FIG. 9A shows the spectrogram of mixed gender mosquito ensemble's acoustic signature on its second harmonic. The horizontal axis is time and the vertical axis is frequency. The male second harmonic near 1,500 Hz (1.5 kHz, 1 kH=1000 Hertz) is slightly higher than the female second harmonic at about 1,100 Hz (1.1. kHz). FIG. 9B shows the spectrogram of mixed gender mosquito ensemble's acoustic signature on its second harmonic. The horizontal axis is time and the vertical axis is frequency on a different scale. One can observe that the trace is quite wide as the mosquitoes are executing complex flight maneuvers inside the quite small (10 cm×10 cm×10 cm) cage to avoid the walls and as they accelerate or decelerate the wingbeat frequency changes slightly. Even so, two distinct bands are seen at the second harmonic, a band of males near 1.5 kHz (e.g., about 1580 to 1780 Hz) and a band of females near 1 kHz (e.g., about 1020 to 1229 Hz). These spectrograms show that the gender specific spectral features are different, enabling their differentiation using passive acoustics even in swarms.

FIG. 10A through FIG. 10C are block diagrams that illustrates various remedial systems for generating an optical barrier to pests, according to various embodiments. Such optical barriers are described in U.S. Pat. No. 8,810,411, the entire contents of which are hereby incorporated by reference as if fully set forth herein. FIG. 10A is a diagram that illustrates a system 1000 for generating a barrier to pests, according to one embodiment. The proposed system does not contribute to the chemical or biological load on humans and the environment. This new method practiced by this apparatus provides defense in two or more dimensions for a community, in contrast to traditional approaches requiring physical contact between chemical agents and mosquitoes. The illustrated embodiment does not require cumbersome physical barriers; and eliminates pitfalls related to human negligence during daily installation of nets and inadequate coverage of chemical treatments. The protected volume can be easily and permanently sized for children, thus no adults can re-use the children's devices for their own purpose. In some embodiments, the barrier provides visual feedback on the state of protection by default; therefore no expertise is necessary to evaluate the operational status of the equipment. In some embodiments, where infrared or other light not visible to humans is used, an additional light is added to the device that provides visual feedback of correct orientation and operation.

System 1000 includes a barrier generator 1010 that produces an optical barrier 1020 at least intermittently. In the illustrated embodiment, the barrier generator 1010 includes a power supply 1012, a light source 1014, optical shaping component 1016, controller 1018 and environment sensor 1019. In some embodiments, one or more components of generator 1010 are omitted, or additional components are added. For example, in some embodiments, the environment senor 1019 is omitted and the generator is operated by controller 1018 independently of environmental conditions. In some embodiments, the generator 1010 has a simple single configuration and controller 1018 is also omitted. In some embodiments, the light source 1014 output is suitable for the barrier and the optical shaping component 1016 is omitted.

The power supply 1012 is any power supply known in the art that can provide sufficient power to light source 1014 that the light intensity in the optical barrier is enough to perturb pests, e.g., about one Watts per square centimeter (cm, 1 cm=10⁻² meters). In an example embodiment, the power supply is an outlet from a municipal power grid with a transformer and rectifier to output a direct current voltage of 2.86 Volts and currents between about one and about 60 Amperes. For example, an Agilent 6671A J08-DC Laboratory Power Supply (0-3V, 0-300A) manufactured by Agilent Technologies, Inc., 5301 Stevens Creek Blvd., Santa Clara Calif., is used. Any DC power supply providing sufficient voltage, current, and stability to drive the light source is used in other embodiments. In various other embodiments, the power supply is a battery, a solar cell, a hydroelectric generator, a wind driven generator, a geothermal generator, or some other source of local power.

The light source 1014 is any source of one or more continuous or pulsed optical wavelengths, such as a laser, lased diode, light emitting diode, lightbulb, flashtube, fluorescent bulbs, incandescent bulbs, sunlight, gas discharge, combustion-based, or electrical arcs. Examples of laser or light emitting diode sources in the infrared region include but are not limited to 808 nm, 10350 nm, 10550 nm emitters. While the light source of the barrier can be any kind of regular light source, laser light sources are expected to be more suitable due to the increased abruptness and controlled dispersion of laser sources (making it easier to focus laser beams towards the desired portion of space). A scanning beam is often easier to accomplish using laser beams. For example, an experimental embodiment of light source 1014 is a laser diode emitting a near infrared (NIR) wavelength of 808 nm in a beam with a total power of two Watts. The optical beam produced by this laser experiences dispersion characterized by an angular spread of about +/−100 degrees in one direction and +/−30 degrees in a perpendicular direction.

The optical shaping component 1016 includes one or more optical couplers for affecting the location, size, shape, intensity profile, pulse profile, spectral profile or duration of an optical barrier. An optical coupler is any combination of components known in the art that are used to direct and control an optical beam, such as free space, vacuum, lenses, mirrors, beam splitters, wave plates, optical fibers, shutters, apertures, linear and nonlinear optical elements, Fresnel lens, parabolic concentrators, circulators and any other devices and methods that are used to control light. In some embodiments, the optical shaping component includes one or more controllable devices for changing the frequency, shape, duration or power of an optical beam, such as an acousto-optical modulator (AOM), a Faraday isolator, a Pockels cell, an electro-optical modulator (EOM), a magneto-optic modulator (MOM), an amplifier, a moving mirror/lens, a controlled shape mirror/lens, a shutter, and an iris, among others. For example, an experimental embodiment of the optical shaping component 1016 includes an anti-reflection (AR) coated collimating lens (to turn the diverging beam from the laser into a substantively parallel beam) and a shutter to alternately block and pass the parallel beam. Several manufacturers supply such optical components include Thorlabs, of Newton, N.J.; New Focus, of Santa Clara, Calif.; Edmund Optics Inc., of Barrington, N.J.; Anchor Optics of Barrington, N.J.; CVI Melles Griot of Albuquerque, N. Mex.; Newport Corporation of Irvine, Calif., among others.

In some embodiments, one or more of these optical elements are operated to cause an optical beam to be swept through a portion of space, such as rotating a multifaceted mirror to cause an optical beam to scan across a surface. In some embodiments, the optical shaping component 1016 includes one or more sensors 1017 to detect the operational performance of one or more optical couplers or optical devices of the component 1016, such as light detector to determine the characteristics of the optical beam traversing the component 1016 or portions thereof or a motion detector to determine whether moving parts, if any, are performing properly. Any sensors known in the art may be used, such as a photocell, a bolometer, a thermocouple, temperature sensors, a pyro-electric sensor, a photo-transistor, a photo-resistor, a light emitting diode, a photodiode, a charge coupled device (CCD), a CMOS sensor, or a one or two dimensional array of CCDs.or CMOS sensors or temperature sensors. In some embodiments, one or more of the optical components are provided by one or more micro-electrical-mechanical systems (MEMS).

The controller 1018 controls operation of at least one of the power supply 1012 or the light sources 1014 or the optical shaping component 1016. For example, the controller changes the power output of the power supply 1012 to provide additional power when the barrier is to be on, and to conserve power when the barrier is to be off, e.g., according to a preset schedule or external input. In some embodiments, the controller receives data from one or more sensors 1017 in the component 1016, or environment sensor 1019, and adjusts one or more controlling commands to the power supply 1012, light source 1014 or device of the component 1016 in response to the output from the sensors. In some embodiments one or more feedback loops, interlocks, motion sensors, temperature sensors, light sensors are used, alone or in some combination. In some embodiments, the controller can be used to choose between different setups which define controlling schemes between different operation modes based on the input from the sensors or any input from the user. In some embodiments, the controller is used to drive any other devices which are synchronized with the optical barrier generator. Any device known in the art may be used as the controller, such as special purpose hardware like an application specific integrated circuit (ASIC) or a general purpose computer as depicted in FIG. 7 or a programmable chip set as depicted in FIG. 8, all described in more detail in a later section.

The environment sensor 1019 detects one or more environmental conditions, such as ambient light for one or more wavelengths or wavelength ranges or in one or more directions, ambient noise for one or more acoustic frequencies or directions, temperature, temperature gradients in one or more directions, humidity, pressure, wind, chemical composition of air, movement of the ground or the environment, vibration, dust, fog, electric charge, magnetic fields or rainfall, among others, alone or in some combination. Any environment sensor known in the art may be used. There are a huge number of sensor vendors, including OMEGA Engineering of Stamford, Conn. In some embodiments, the environment sensor 1019 is omitted. In embodiments that include the environment sensor 1019, the controller 1018 uses data from the environment sensor 1019 to control the operation of one or more of the power supply 1012, light source 1015 or shaping component 1016. For example, in some embodiments under conditions of high ambient light, light intensity output by the source 1014 or component 1016 is increased. As another example, in some embodiments under conditions of near 100% ambient humidity, optical shaping component 1016 is adapted to reshape a beam to compensate for increased scattering.

In at least some states (e.g., during a scheduled period or in response to a value output by the environment sensor 1019 falling within a predetermined range) the barrier generator 1010 produces an optical barrier 1020. The optical barrier 1020 comprises an optical waveform of sufficient power to perturb a pest and extends in a portion of space related to the generator 1010. In some embodiments, the power of the waveform in the portion of space is limited by a maximum power, such as a maximum safe power for the one or more wavelengths of the optical waveform. For example, the illustrated optical barrier occupies a portion of space below the generator. The portion of space can be described as a thin sheet of height 1026, width 1024 and thickness 1022, where thickness 1022 represents the narrowest dimension of the barrier 1020. Outside the optical barrier 1020, the optical waveform, if present, is not sufficiently strong to adequately perturb a pest. In some embodiments, the optical barrier 1020 is confined in one or more dimensions by walls or floor of a solid structure, or some combination. In some embodiments, the thin sheet barrier 1020 is configured to cover an opening in a wall, such as a door or window.

Effective perturbation of a pest is illustrated in FIG. 10A as causing a pest to travel a pest track 1030 that turns back rather than crosses the optical barrier 1020. In some embodiments, effective perturbation of a pest includes immobilizing the pest or disabling or killing a living pest. Thus, the optical barrier generator 1010 is configured to emit light of an optical waveform above a threshold power in a portion of space 1020 positioned relative to the generator 1010, wherein the particular optical waveform above the threshold power is effective at perturbing a pest to human activity. Pest perturbation is not observed in normal sunlight, which corresponds to visible light at power density levels below about 30 milliWatts per square centimeter, i.e., less than about 0.03 Watts per square centimeter (W/cm²). Perturbations were always observed at power density levels above about 10 W/cm².

In various other embodiments, the optical barrier occupies different portions of space relative to the generator, too numerous to illustrate. However, FIG. 10B and FIG. 10C depict two alternative portions of space to be occupied by optical barriers. FIG. 10B is a diagram that illustrates an example optical barrier 1046, according to another embodiment. A hollow conical optical barrier 1046 is generated below barrier generator 1042 and surrounds conical protected volume 1048. In some of these embodiments, the optical barrier 1046 is produced by causing a narrow optical beam that produces an individual spot, such as spot 1044, to sweep along a circular track on a horizontal surface below the barrier generator. The circular track is desirably circumscribed in a time short compared to the transit time of a pest through the beam that produces the spot 1044.

FIG. 10C is a diagram that illustrates an example optical barrier 1056, according to still another embodiment. In the illustrated embodiment, multiple barrier generators 1052 surround an asset 1060, such as a person, or a fixed asset such as a loading dock or pier, or a temporarily fixed asset such as a tent where one or more persons reside. Each barrier generator 1052 generates a fan-shaped optical barrier 1056. In the illustrated embodiment, each optical barrier 1056 is a thin fan that covers an obtuse angle of about 120 degrees in one plane and sufficiently thick in a perpendicular plane (not shown) to perturb a pest. The distance of an outer edge of the barrier 1056, e.g., an edge farthest from the barrier generator 1052, is determined by attenuation or spreading of the light beam forming the barrier 1056. In some embodiments, the optical barrier 1056 is produced by causing a narrow optical beam, e.g., pencil beam 1054, to sweep through the angular range about the barrier generator 1052. The sweep is desirably completed in a time short compared to the transit time of a pest through the beam 1054. The barrier generators 1052 are spaced so that the fan shaped barrier of one generator 1052 covers come or all of the space not covered by a fan of an adjacent barrier generator 1052 to perturb pests that might otherwise reach asset 1060.

FIG. 11A and FIG. 11B are block diagrams that illustrate operation of example remedial system based on a UAV 1110, according to an embodiment. The remedial system includes the vehicle 1110 to which is affixed a sticky panel 1112. In some embodiments the sticky panel is a substrate coated with an environmentally safe yet efficacious substance to capture most insects, such as naturally occurring sugars including honey or maple syrup or some combination. A suitable substrate is a net composed of netting fabric mounted to a frame that allows air to pass, reducing drag on the UAV, but preventing the passage of individuals in the target swarm. In some embodiments, the panel is configured with contact pesticides like ivermectin, electrocution, fungus, bacteria, or other environmentally mundane alternatives.

In various embodiments, other slow to cure sticky substances are used, alone or in some combination. These include general household items such as molasses, peanut butter, corn syrup, jelly, flour-water paste etc., and also include natural adhesives such as tree saps from various trees, beeswax, tar, etc., and other adhesives/glues, such as animal/fish glue, starch based adhesives, rubber cement. The adhesives are applied using an appropriate solvent. Additionally a tacky tape such as fly tape can be used, including commercially available tapes and sticky sheets, such as Scotch tapes.

In an example embodiment, honey is dissolved in 95% ethyl alcohol. The solvent properties were determined experimentally to minimize honey usage and maximize stickiness. Mosquito netting substrate is stretched on a frame then dipped into the honey solution. The coated netting is removed and the alcohol is let to evaporate. A thin layer of honey remains on the net and it is able to capture the mosquitoes. After use to capture one or more target individuals, the netting is dipped into the honey solution again, the mosquitoes are killed, preserved and washed away and the net's coating is replenished. It was discovered that isopropyl alcohol does not work. Both honey and ethyl alcohol are widely available, environmentally friendly and not harmful to humans. The preserved mosquitoes can be researched or filtered out.

During operation the vehicle 1110 is directed toward swarm 1190a or individual by one of the tracking methods described herein, such as a triangulation system of FIG. 1, or a phased array of FIG. 4A or FIG. 4B, deployed remotely or included on vehicle 1110. As shown in FIG. 11B, after moving through the swarm 1190 a, a captured portion 1190c of the swarm is captured by the sticky panel 1112, leaving a reduced swarm 1190b in the environment, thus reducing the risk of disease spread by this type of pest. When a net is used as the substrate in the front of the UAV, as depicted, the more holes in the net, the better the net collects a portion of the swarm. If the net is on top of the UAV, then the propellers suck the individuals (e.g., mosquitoes) onto the sticky net. If the net is below the UAV, then the propellers push the individuals (e.g., mosquitoes) onto the sticky net. More than one pass of the UAV through the swarm is effective in some embodiment in which the individuals regroup or the vehicle is fast enough to turn back for a second pass before the swarm disperses.

FIG. 11C is a block diagram that illustrates operation of example remedial system based on a UAV with an on board directional microphone or array, according to another embodiment. Though depicted below the swarm 1190a for purposes of illustration, in many embodiments, the UAV 1110 is likely at a height of 3 to 5 meters above the ground and looking down on the layer of air where mosquito swarms are most probable. An advantage of looking down is tha the background acoustic noise is less than when the lobe is pointed upward. In other embodiments, the search and intercept is in the horizontal plane or in both vertical and horizontal planes. The same search principles apply as described next. In the depicted embodiment, a separate remote tracking system is optional.

Initially the UAV is moving indirection 11301 with a forward looking main lobe 1140a of a directional array or microphone, such as a shotgun microphone. No signal of the target pest (e.g., warm 1190a) is detected. The UAV is then instructed (manually or by a search algorithm on a processor) to change direction (e.g., in the vertical plane as depicted in FIG. 11C), such that the UAV is headed in direction 1130b and the main lobe 1140b is directed upward. Again, no signal of the target pest is detected in the main lobe 1140b. The UAV is then instructed to change direction again, such that the UAV is headed in direction 1130c and the main lobe 1140c is directed further upward. In this direction a signal of the target pest is detected in the main lobe 1140c, and the UAV can proceed in that direction. In some embodiments, to make sure the UAV passes through the center of target pest, the UAV is again instructed to continue to change upward direction again, such that the UAV is headed in direction 1130d and the main lobe 1140d is directed further upward. In the illustrated embodiment, it is clear the direction has taken the UAV above the target pest, and the UAV is operated to reverses direction such that the UAV is headed in direction 1130e. In this direction the main lobe 1140e is directed again toward the target pest. These maneuvers can be repeated as the UAV continues to snake toward its target using its on-board directional microphones or array. In some embodiments, these maneuvers are controlled by a remote processor; but, in some embodiments, these corrective maneuvers are determined, in whole or in part, by a processor on board the UAV.

For example a shotgun microphone mounted on a UAV can find the sound emitter following this simple method. 1) Keep rotating until a signal is detected. 2) Move towards the source. 3) Keep rotating the UAV +/−20 degrees left and right to ensure directional lock. 4) Keep rotating the UAV +/−20 degrees up and down to ensure that the emitter's height is determined e.g., from the parallax. Iteratively converging on the sound emitter the UAV will find the mosquito and the swarm.

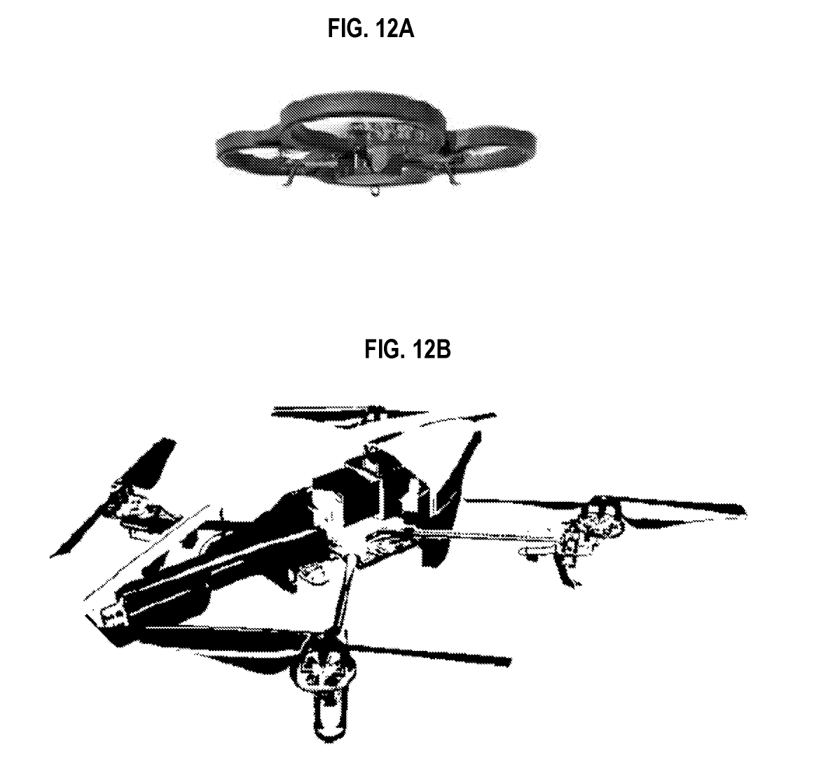

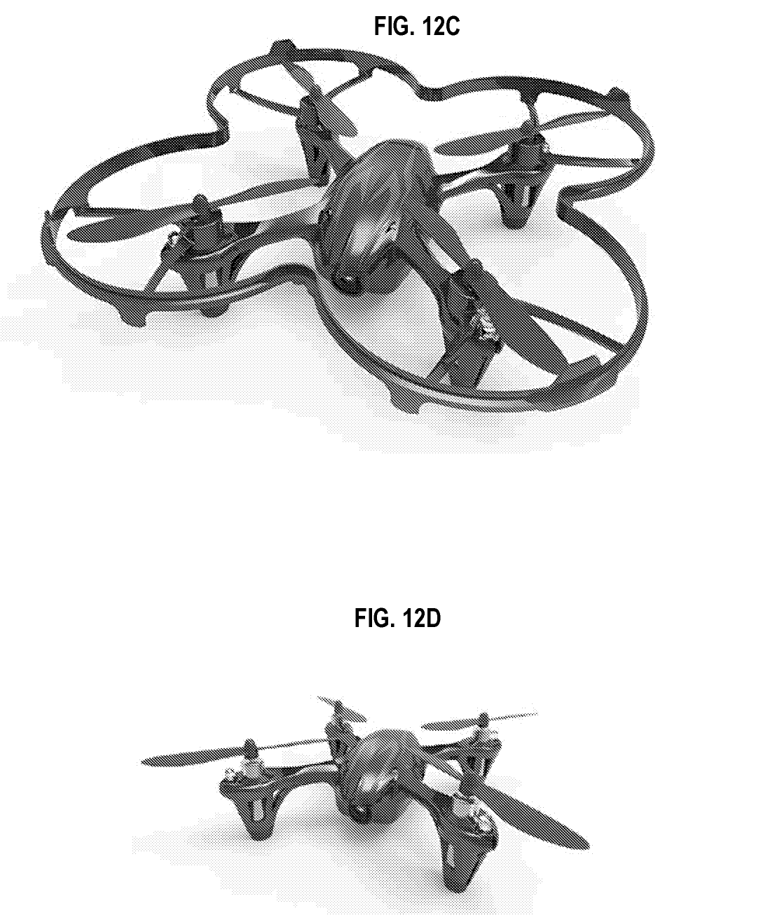

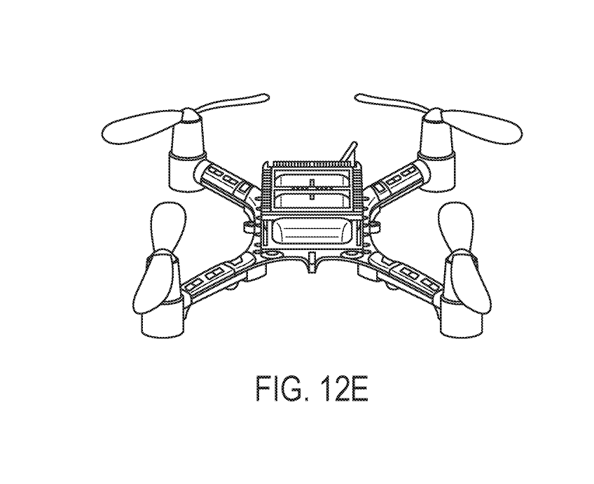

In some embodiments, UAVs, such a UAVs equipped with cameras or other sensing or surveillance equipment, constitute a threat to the rights or welfare of persons or property. In these embodiments, the UAVs are themselves pests to be remediated. FIG. 12A through FIG. 12E are photographs that illustrates various UAVs that are example pests or example platforms for a virtual phased array or remedial system or both, according to various embodiments. Example UAVs include Parrot UAV, Hubsan X4 UAV, CrazyFlie 2 UAV, with and without bumpers surrounding propellers when configured for indoor operation.

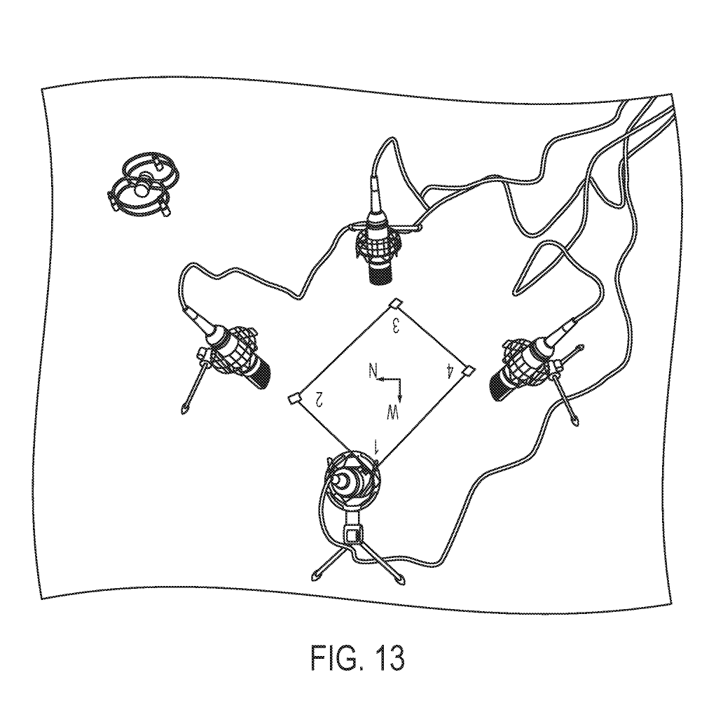

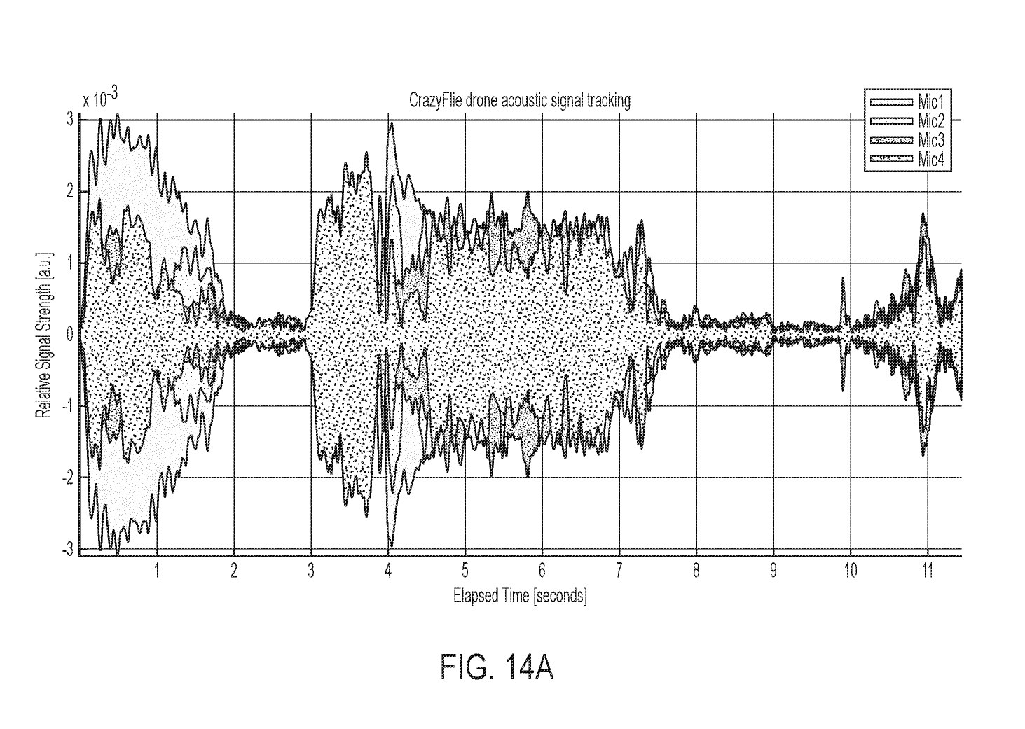

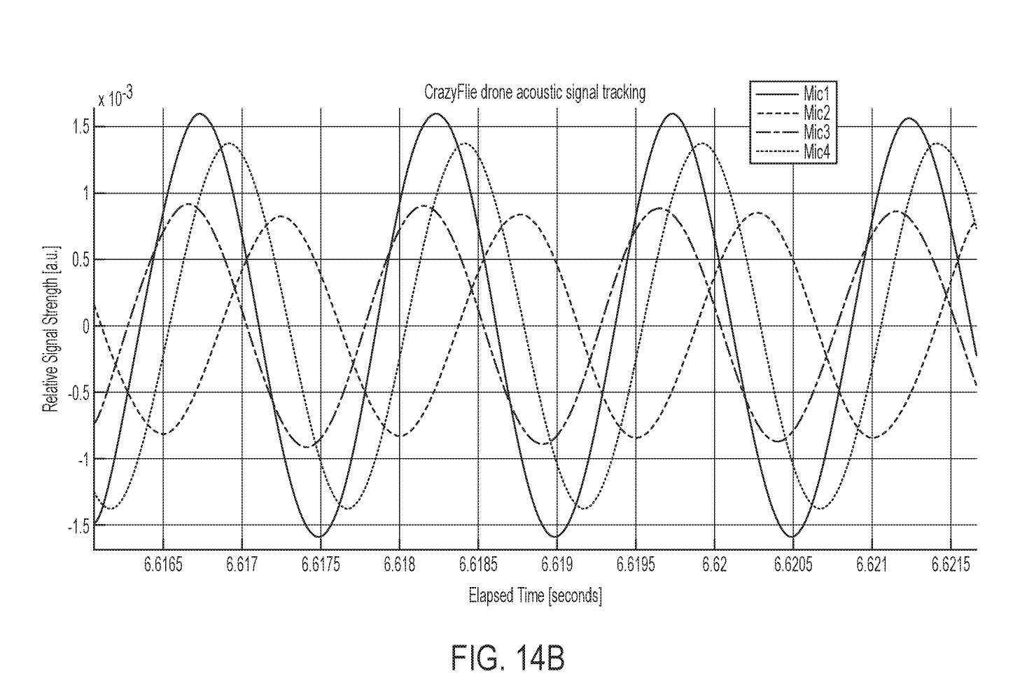

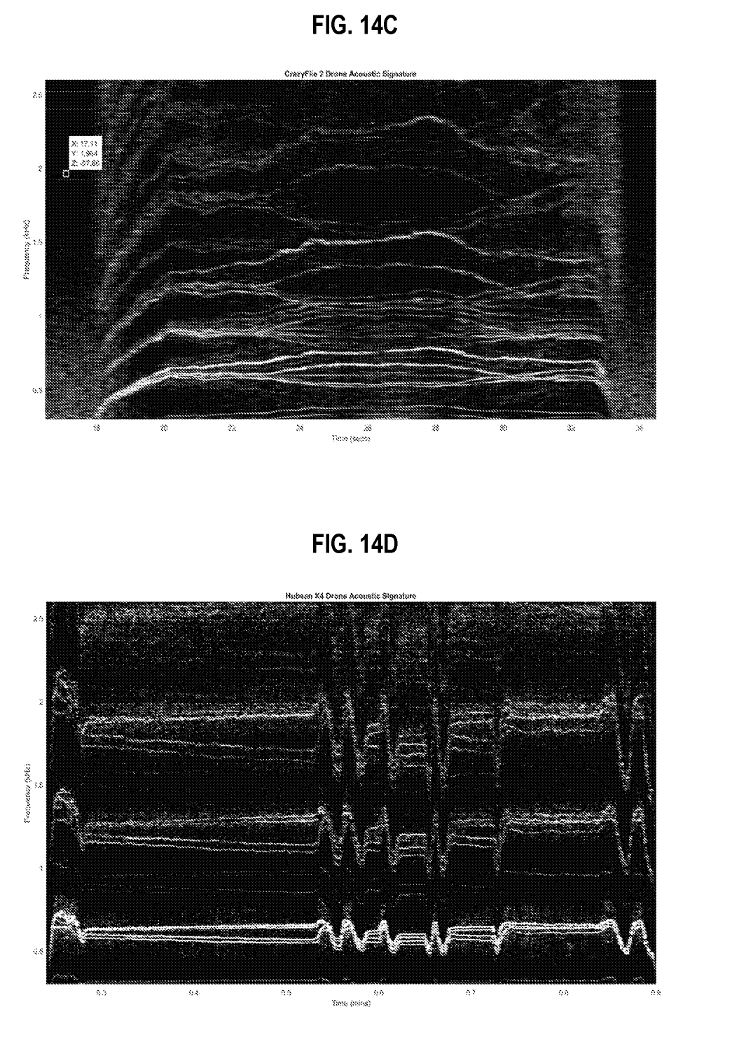

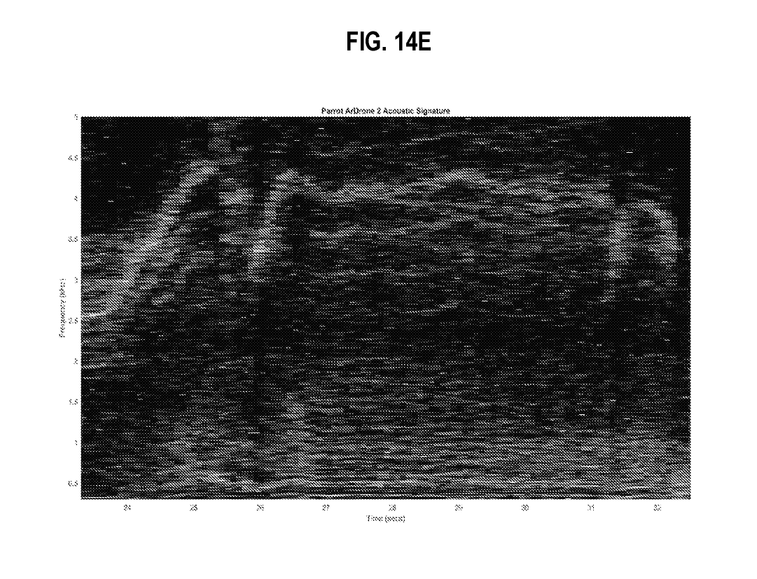

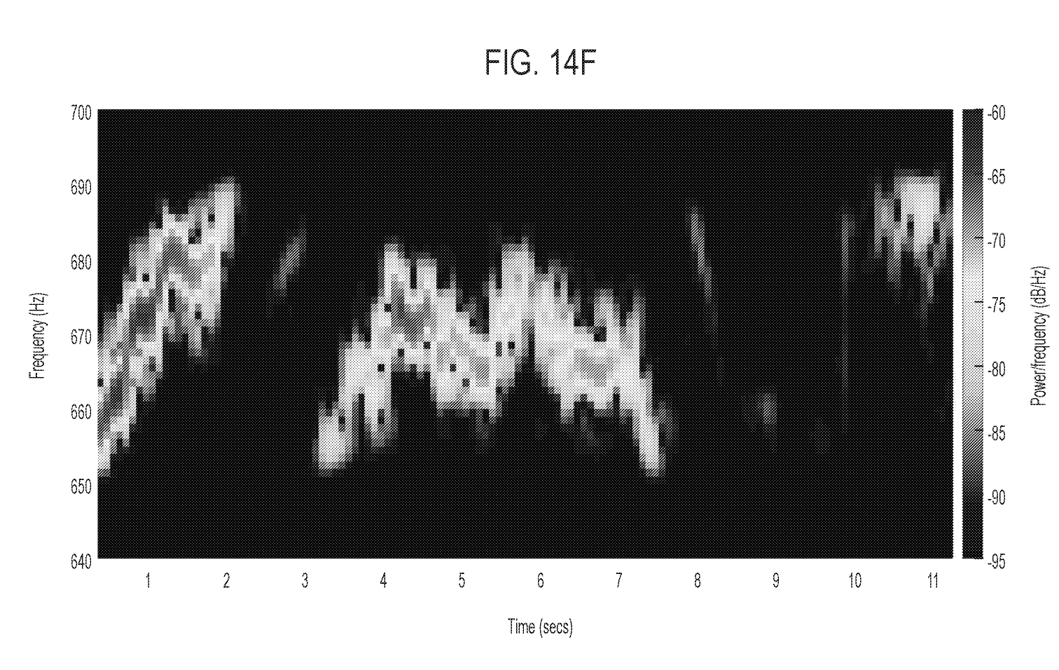

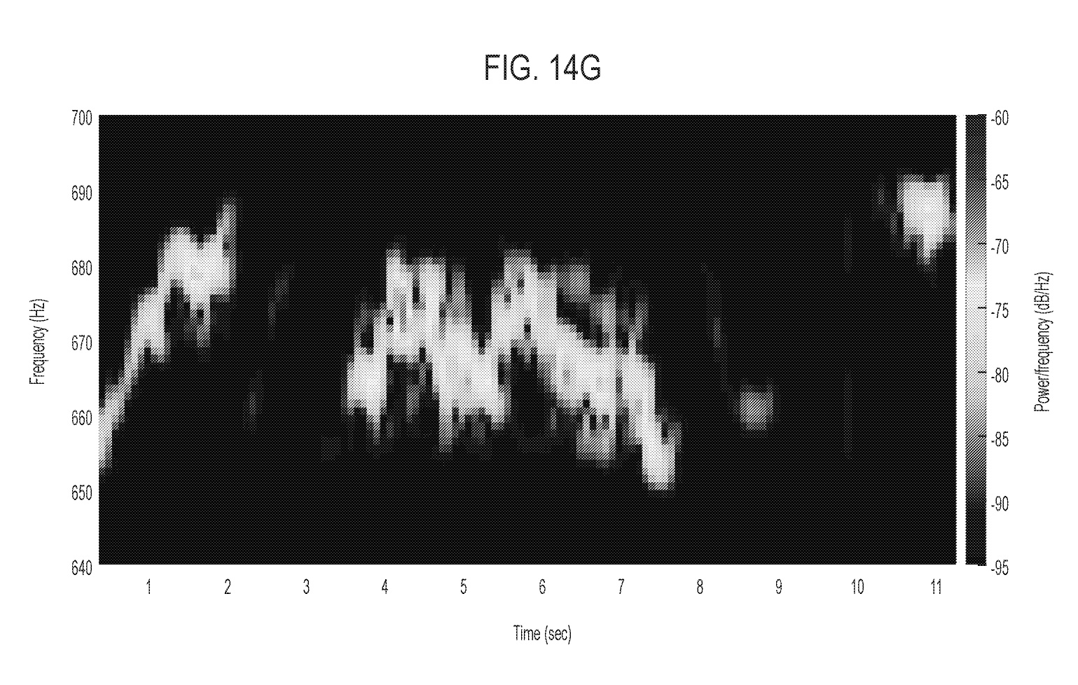

FIG. 13 is a photograph of an example experimental setup to detect unique acoustic signatures of a UAVs, according to an embodiment. Four Tascam TM-80 Studio Condenser microphones are designated, clockwise from the left, N, E, S, W for north, east, south, west, respectively. FIG. 14A is a graph that illustrates an example pressure signal from a single CraxyFlie™ UAV received at an array of four microphones depicted in FIG. 13, according to an embodiment. The horizontal axis is time in seconds, and is over 11 seconds long. The vertical axis, centered on a value of zero, indicates positive and negative acoustic pressures. Four different shades of grey indicate the outer envelope of the pressure signal in the 655-685 Hz band for the corresponding four microphones. The 655-685 Hz bandlimited signal visualized clearly shows the relative amplitude temporal evolution of the microphone signals Amplitudes vary significantly over time as the UAV maneuvers near and within the array of microphones. At any one time the amplitude received at different microphones can be quite different. The dominant frequencies of the signal also varies as each rotor of the UAV emits a frequency and harmonics related to its own rotational speed and different rotors may rotate at different speeds to cause a particular motion by the UAV.

The phase of the dominant frequencies received at each microphone also varies depending on the distance of that microphone from the UAV. FIG. 14B is a graph that depicts an example relative phase of pressure signals at four microphones from a single UAV over a few cycles of a dominant frequency, according to an embodiment. The horizontal axis is time in a tiny time interval of 5 milliseconds (0.005 seconds) that resolves pressure variations within a dominant individual frequency. The vertical axis is pressure signal on a scale half that of FIG. 14A. This is essentially a zoom of the signals depicted in FIG. 14A and clearly indicates that the phase of the signal sensed by multiple microphones can be recovered and used to determine direction and distance. Direction from each pair of microphones in the array to the UAV can be estimated using the phase difference between the two microphones. With four microphones arranged as depicted in FIG. 13, four directions can be used to triangulate on position of a target pest robustly (e.g., overdetermined triangulation can be used with an error minimization scheme, such as least squares, to obtain a location more robust against errors). The more microphones and the more spatially distributed, the better is the location solution. Amplitude can also be used to estimate range to a target pest of known strength. Between several estimates of range or direction or both, a useful estimate of UAV position relative to the microphone array can be determined. Based on the dominant frequencies and historical or training observations, one may be able to estimate also the maneuver being executed by the UAV. In some embodiments, some information on what is being observed can be gained from the past trajectory.

FIG. 14C through FIG. 14G are graphs that illustrate example spectrograms that display unique acoustic signatures of various operations of various UAVs, according to various embodiments. These show spectrograms of the sound recorded for three UAVs of different manufacture and size. One can see that their spectral features are markedly different from that of mosquitoes, enabling their differentiation. One can also see that their sound spectrum changes as they change their motion, enabling the collection of information related to their motion. In some embodiments, the type of drone and its load status are determined if the drone's acoustic fingerprint is included in a database.

FIG. 14C shows a CrazyFlie 2 UAV acoustic signature visualized as spectrogram. Note that the frequencies of the UAV's four propellers can be quite different. The signature contains many harmonics, however the spectral lines are very narrow and predictable from a witness microphone (a microphone mounted on the UAV, e.g., witness microphones at each propeller) that allows efficient subtraction. FIG. 14D shows a Hubsan X4 UAV acoustic signature visualized as spectrogram. Note that the frequencies of the four propellers can be quite different. FIG. 14E shows a Parrot UAV 2 UAV acoustic signature visualized as spectrogram. Again note that the frequencies of the four propellers can be quite different. The signature contains many harmonics and the spectral lines are blurred. More complex but deterministic approaches would be involved to clean the data through the use of the witness microphone(s) mounted on the UAV itself.

FIG. 14F and FIG. 14G shows a CrazyFlie 2 UAV acoustic signature visualized as spectrogram at each of two different microphones, respectively, of the four depicted in FIG. 13. These two spectrograms clearly indicate that while the frequency evolution of the emitter is the same from microphone to microphone, the amplitude ratio between corresponding pixels is clearly changing as the UAV moves relatively to the microphone array. From this information one can compute the momentary direction of the UAV. Using signals from multiple rotors can enhance the accuracy.

Although processes, equipment, and data structures are depicted in FIG. 1 or FIG. 4A through FIG. 4B as integral blocks in a particular arrangement for purposes of illustration, in other embodiments one or more processes or data structures, or portions thereof, are arranged in a different manner, on the same or different hosts, in one or more databases, or are omitted, or one or more different processes or data structures are included on the same or different hosts.

FIG. 15 is a block diagram that illustrates a computer system 1500 upon which an embodiment of the invention may be implemented. Computer system 1500 includes a communication mechanism such as a bus 1510 for passing information between other internal and external components of the computer system 1500. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1500, or a portion thereof, constitutes a means for performing one or more steps of one or more methods described herein.

A sequence of binary digits constitutes digital data that is used to represent a number or code for a character. A bus 1510 includes many parallel conductors of information so that information is transferred quickly among devices coupled to the bus 1510. One or more processors 1502 for processing information are coupled with the bus 1510. A processor 1502 performs a set of operations on information. The set of operations include bringing information in from the bus 1510 and placing information on the bus 1510. The set of operations also typically include comparing two or more units of information, shifting positions of units of information, and combining two or more units of information, such as by addition or multiplication. A sequence of operations to be executed by the processor 1502 constitutes computer instructions.

Computer system 1500 also includes a memory 1504 coupled to bus 1510. The memory 1504, such as a random access memory (RAM) or other dynamic storage device, stores information including computer instructions. Dynamic memory allows information stored therein to be changed by the computer system 1500. RAM allows a unit of information stored at a location called a memory address to be stored and retrieved independently of information at neighboring addresses. The memory 1504 is also used by the processor 1502 to store temporary values during execution of computer instructions. The computer system 1500 also includes a read only memory (ROM) 1506 or other static storage device coupled to the bus 1510 for storing static information, including instructions, that is not changed by the computer system 1500. Also coupled to bus 1510 is a non-volatile (persistent) storage device 1508, such as a magnetic disk or optical disk, for storing information, including instructions, that persists even when the computer system 1500 is turned off or otherwise loses power.

Information, including instructions, is provided to the bus 1510 for use by the processor from an external input device 1512, such as a keyboard containing alphanumeric keys operated by a human user, or a sensor. A sensor detects conditions in its vicinity and transforms those detections into signals compatible with the signals used to represent information in computer system 1500. Other external devices coupled to bus 1510, used primarily for interacting with humans, include a display device 1514, such as a cathode ray tube (CRT) or a liquid crystal display (LCD), for presenting images, and a pointing device 1516, such as a mouse or a trackball or cursor direction keys, for controlling a position of a small cursor image presented on the display 1514 and issuing commands associated with graphical elements presented on the display 1514.

In the illustrated embodiment, special purpose hardware, such as an application specific integrated circuit (IC) 1520, is coupled to bus 1510. The special purpose hardware is configured to perform operations not performed by processor 1502 quickly enough for special purposes. Examples of application specific ICs include graphics accelerator cards for generating images for display 1514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1500 also includes one or more instances of a communications interface 1570 coupled to bus 1510. Communication interface 1570 provides a two-way communication coupling to a variety of external devices that operate with their own processors, such as printers, scanners and external disks. In general the coupling is with a network link 1578 that is connected to a local network 1580 to which a variety of external devices with their own processors are connected. For example, communication interface 1570 may be a parallel port or a serial port or a universal serial bus (USB) port on a personal computer. In some embodiments, communications interface 1570 is an integrated services digital network (ISDN) card or a digital subscriber line (DSL) card or a telephone modem that provides an information communication connection to a corresponding type of telephone line. In some embodiments, a communication interface 1570 is a cable modem that converts signals on bus 1510 into signals for a communication connection over a coaxial cable or into optical signals for a communication connection over a fiber optic cable. As another example, communications interface 1570 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1570 sends and receives electrical, acoustic or electromagnetic signals, including infrared and optical signals, that carry information streams, such as digital data.

The term computer-readable medium is used herein to refer to any medium that participates in providing information to processor 1502, including instructions for execution. Such a medium may take many forms, including, but not limited to, non-volatile media, volatile media and transmission media. Non-volatile media include, for example, optical or magnetic disks, such as storage device 1508. Volatile media include, for example, dynamic memory 1504. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1502, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1502, except for carrier waves and other signals.

Logic encoded in one or more tangible media includes one or both of processor instructions on a computer-readable storage media and special purpose hardware, such as ASIC 1520.

Network link 1578 typically provides information communication through one or more networks to other devices that use or process the information. For example, network link 1578 may provide a connection through local network 1580 to a host computer 1582 or to equipment 1584 operated by an Internet Service Provider (ISP). ISP equipment 1584 in turn provides data communication services through the public, world-wide packet-switching communication network of networks now commonly referred to as the Internet 1590. A computer called a server 1592 connected to the Internet provides a service in response to information received over the Internet. For example, server 1592 provides information representing video data for presentation at display 1514.

The invention is related to the use of computer system 1500 for implementing the techniques described herein. According to one embodiment of the invention, those techniques are performed by computer system 1500 in response to processor 1502 executing one or more sequences of one or more instructions contained in memory 1504. Such instructions, also called software and program code, may be read into memory 1504 from another computer-readable medium such as storage device 1508. Execution of the sequences of instructions contained in memory 1504 causes processor 1502 to perform the method steps described herein. In alternative embodiments, hardware, such as application specific integrated circuit 1520, may be used in place of or in combination with software to implement the invention. Thus, embodiments of the invention are not limited to any specific combination of hardware and software.

The signals transmitted over network link 1578 and other networks through communications interface 1570, carry information to and from computer system 1500. Computer system 1500 can send and receive information, including program code, through the networks 1580, 1590 among others, through network link 1578 and communications interface 1570. In an example using the Internet 1590, a server 1592 transmits program code for a particular application, requested by a message sent from computer 1500, through Internet 1590, ISP equipment 1584, local network 1580 and communications interface 1570. The received code may be executed by processor 1502 as it is received, or may be stored in storage device 1508 or other non-volatile storage for later execution, or both. In this manner, computer system 1500 may obtain application program code in the form of a signal on a carrier wave.

Various forms of computer readable media may be involved in carrying one or more sequence of instructions or data or both to processor 1502 for execution. For example, instructions and data may initially be carried on a magnetic disk of a remote computer such as host 1582. The remote computer loads the instructions and data into its dynamic memory and sends the instructions and data over a telephone line using a modem. A modem local to the computer system 1500 receives the instructions and data on a telephone line and uses an infra-red transmitter to convert the instructions and data to a signal on an infra-red a carrier wave serving as the network link 1578. An infrared detector serving as communications interface 1570 receives the instructions and data carried in the infrared signal and places information representing the instructions and data onto bus 1510. Bus 1510 carries the information to memory 1504 from which processor 1502 retrieves and executes the instructions using some of the data sent with the instructions. The instructions and data received in memory 1504 may optionally be stored on storage device 1508, either before or after execution by the processor 1502.

FIG. 16 illustrates a chip set 1600 upon which an embodiment of the invention may be implemented. Chip set 1600 is programmed to perform one or more steps of a method described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1600, or a portion thereof, constitutes a means for performing one or more steps of a method described herein.

In one embodiment, the chip set 1600 includes a communication mechanism such as a bus 1601 for passing information among the components of the chip set 1600. A processor 1603 has connectivity to the bus 1601 to execute instructions and process information stored in, for example, a memory 1605. The processor 1603 may include one or more processing cores with each core configured to perform independently. A multi-core processor enables multiprocessing within a single physical package. Examples of a multi-core processor include two, four, eight, or greater numbers of processing cores. Alternatively or in addition, the processor 1603 may include one or more microprocessors configured in tandem via the bus 1601 to enable independent execution of instructions, pipelining, and multithreading. The processor 1603 may also be accompanied with one or more specialized components to perform certain processing functions and tasks such as one or more digital signal processors (DSP) 1607, or one or more application-specific integrated circuits (ASIC) 1609. A DSP 1607 typically is configured to process real-world signals (e.g., sound) in real time independently of the processor 1603. Similarly, an ASIC 1609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1603 and accompanying components have connectivity to the memory 1605 via the bus 1601. The memory 1605 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 1605 also stores the data associated with or generated by the execution of one or more steps of the methods described herein.

FIG. 17 is a block diagram that illustrates example components of a mobile terminal 1700 (e.g., cell phone handset) for communications, which is capable of operating in the system of FIG. 2C, according to one embodiment. In some embodiments, mobile terminal 1701, or a portion thereof, constitutes a means for performing one or more steps described herein. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1703, a Digital Signal Processor (DSP) 1705, and a receiver/transmitter unit including a microphone gain control unit and a speaker gain control unit. A main display unit 1707 provides a display to the user in support of various applications and mobile terminal functions that perform or support the steps as described herein. The display 1707 includes display circuitry configured to display at least a portion of a user interface of the mobile terminal (e.g., mobile telephone). Additionally, the display 1707 and display circuitry are configured to facilitate user control of at least some functions of the mobile terminal. An audio function circuitry 1709 includes a microphone 1711 and microphone amplifier that amplifies the speech signal output from the microphone 1711. The amplified speech signal output from the microphone 1711 is fed to a coder/decoder (CODEC) 1713.

A radio section 1715 amplifies power and converts frequency in order to communicate with a base station, which is included in a mobile communication system, via antenna 1717. The power amplifier (PA) 1719 and the transmitter/modulation circuitry are operationally responsive to the MCU 1703, with an output from the PA 1719 coupled to the duplexer 1721 or circulator or antenna switch, as known in the art. The PA 1719 also couples to a battery interface and power control unit 1720.

In use, a user of mobile terminal 1701 speaks into the microphone 1711 and his or her voice along with any detected background noise is converted into an analog voltage. The analog voltage is then converted into a digital signal through the Analog to Digital Converter (ADC) 1723. The control unit 1703 routes the digital signal into the DSP 1705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1725 for compensation of any frequency-dependent impairments that occur during transmission though the air such as phase and amplitude distortion. After equalizing the bit stream, the modulator 1727 combines the signal with a RF signal generated in the RF interface 1729. The modulator 1727 generates a sine wave by way of frequency or phase modulation. In order to prepare the signal for transmission, an up-converter 1731 combines the sine wave output from the modulator 1727 with another sine wave generated by a synthesizer 1733 to achieve the desired frequency of transmission. The signal is then sent through a PA 1719 to increase the signal to an appropriate power level. In practical systems, the PA 1719 acts as a variable gain amplifier whose gain is controlled by the DSP 1705 from information received from a network base station. The signal is then filtered within the duplexer 1721 and optionally sent to an antenna coupler 1735 to match impedances to provide maximum power transfer. Finally, the signal is transmitted via antenna 1717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1701 are received via antenna 1717 and immediately amplified by a low noise amplifier (LNA) 1737. A down-converter 1739 lowers the carrier frequency while the demodulator 1741 strips away the RF leaving only a digital bit stream. The signal then goes through the equalizer 1725 and is processed by the DSP 1705. A Digital to Analog Converter (DAC) 1743 converts the signal and the resulting output is transmitted to the user through the speaker 1745, all under control of a Main Control Unit (MCU) 1703 which can be implemented as a Central Processing Unit (CPU) (not shown).

The MCU 1703 receives various signals including input signals from the keyboard 1747. The keyboard 1747 and/or the MCU 1703 in combination with other user input components (e.g., the microphone 1711) comprise a user interface circuitry for managing user input. The MCU 1703 runs a user interface software to facilitate user control of at least some functions of the mobile terminal 1701 as described herein. The MCU 1703 also delivers a display command and a switch command to the display 1707 and to the speech output switching controller, respectively. Further, the MCU 1703 exchanges information with the DSP 1705 and can access an optionally incorporated SIM card 1749 and a memory 1751. In addition, the MCU 1703 executes various control functions required of the terminal. The DSP 1705 may, depending upon the implementation, perform any of a variety of conventional digital processing functions on the voice signals. Additionally, DSP 1705 determines the background noise level of the local environment from the signals detected by microphone 1711 and sets the gain of microphone 1711 to a level selected to compensate for the natural tendency of the user of the mobile terminal 1701.

The CODEC 1713 includes the ADC 1723 and DAC 1743. The memory 1751 stores various data including call incoming tone data and is capable of storing other data including music data received via, e.g., the global Internet. The software module could reside in RAM memory, flash memory, registers, or any other form of writable storage medium known in the art. The memory device 1751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1749 carries, for instance, important information, such as the cellular phone number, the carrier supplying service, subscription details, and security information. The SIM card 1749 serves primarily to identify the mobile terminal 1701 on a radio network. The card 1749 also contains a memory for storing a personal telephone number registry, text messages, and user specific mobile terminal settings.

In some embodiments, the mobile terminal 1701 includes a digital camera comprising an array of optical detectors, such as charge coupled device (CCD) array 1765. The output of the array is image data that is transferred to the MCU for further processing or storage in the memory 1751 or both. In the illustrated embodiment, the light impinges on the optical array through a lens 1763, such as a pin-hole lens or a material lens made of an optical grade glass or plastic material. In the illustrated embodiment, the mobile terminal 1701 includes a light source 1761, such as a LED to illuminate a subject for capture by the optical array, e.g., CCD 1765. The light source is powered by the battery interface and power control module 1720 and controlled by the MCU 1703 based on instructions stored or loaded into the MCU 1703.

In some embodiments, the mobile terminal 1701 includes a data interface 1771 such as an USB port. Using the data interface 1771 digital metadata about the acoustic input or digital input (e.g., from a remote directional microphone) or digital output of a processing step is input to or output from the MCU 1703 of the mobile terminal 1701.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article. As used herein, unless otherwise clear from the context, a value is “about” another value if it is within a factor of two (twice or half) of the other value.

1. An system comprising:
a directional acoustic sensor;
at least one processor; and
at least one memory including one or more sequences of instructions,
the at least one memory and the one or more sequences of instructions configured to, with the at least one processor, cause an apparatus to track an individual or swarm of pests based on direction and acoustic signatures within a beam of the directional acoustic sensor, which acoustic signature uniquely identifies a type of pest.

2. A system as recited in claim 1, further comprising:
a remedial apparatus configured for remedial action;
wherein the at least one memory and the one or more sequences of instructions are further configured to, with the at least one processor, cause the remedial apparatus to direct remedial action against the individual or swarm of pests.

3. A system as recited in claim 2, wherein the remedial apparatus comprises an optical barrier.

4. A system as recited in claim 1, wherein the pest is an insect.

5. A system as recited in claim 1, wherein the pest is a mosquito.

6. A system as recited in claim 1, wherein
the directional acoustic sensor comprises a plurality of acoustic sensors configured to produce a corresponding plurality of acoustic time series;
the at least one memory and the one or more sequences of instructions are further configured to, with the at least one processor, cause the apparatus to perform the steps of:
storing data that indicates relative locations of the plurality of acoustic sensors;
detecting a distinctive event in each of the plurality of acoustic time series;
determining a corresponding plurality of times that the distinctive event occurs in the plurality of acoustic time series; and
determining a location or direction for the distinctive event based on the relative locations of the plurality of acoustic sensors and the plurality of times.

7. A system as recited in claim 1, wherein
the directional acoustic sensor comprises a plurality of directional acoustic sensors configured to produce a corresponding plurality of acoustic time series;
the at least one memory and the one or more sequences of instructions are further configured to, with the at least one processor, cause the apparatus to perform the steps of
storing data that indicates relative locations and directions of the plurality of directional acoustic sensors;
detecting a pest acoustic signature in the plurality of acoustic time series;
determining an amplitude of the pest signature in the plurality of acoustic time series
determining a location or direction or number of pests based on the amplitude of the pest signature in the plurality of acoustic time series and the relative locations and directions of the plurality of acoustic sensors.
